(19) United States
(12) Patent Application Publication
(10) Pub. No.: US 2026/0134603 A1
(43) Pub. Date: May 14, 2026

(54) GENERATING ANIMATABLE THREE-DIMENSIONAL CHARACTERS USING COMPOSITIONAL MULTI-VIEW DIFFUSION

(71) Applicant: NVIDIA CORPORATION, Santa Clara, CA (US)

(72) Inventors: Yangyi HUANG, Hangzhou (CN); Ye YUAN, State College, PA (US); Xueting LI, San Jose, CA (US); Umar IQBAL, Danville, CA (US); Jan KAUTZ, Lexington, MA (US)

(21) Appl. No.: 19/344,281

(22) Filed: Sep. 29, 2025

Related U.S. Application Data
(60) Provisional application No. 63/720,104, filed on Nov. 13, 2024.

(51) Int. Cl. G06T 13/40; G06T 15/06; G06T 15/20; G06T 15/50

(52) U.S. Cl. CPC G06T 13/40; G06T 15/06; G06T 15/20; G06T 15/506

(57) ABSTRACT

The disclosed method of generating an animatable representation of a character includes generating, based on a global representation of the character, one or more local views, generating, based on the global representation of the character and the one or more local views, one or more local ray maps, generating, using a trained diffusion model and a trained machine learning model and based on the one or more local views and the one or more local ray maps, one or more multi-part local views, and generating, based on the global representation of the character and the one or more multi-part local views, a refined representation of the character.

### CROSS-REFERENCE TO RELATED APPLICATIONS

This application claims priority benefit of the United States Provisional Patent Application titled, “TECHNIQUES FOR GENERATING ANIMATABLE THREE-DIMENSIONAL CHARACTERS USING COMPOSITIONAL MULTI-VIEW DIFFUSION,” filed on Nov. 13, 2024, and having Ser. No. 63/720,104. The subject matter of this related application is hereby incorporated herein by reference.

### BACKGROUND

### Technical Field

Embodiments of the present disclosure relate generally to computer science, artificial intelligence, and machine learning, and more specifically, to generating animatable three-dimensional characters using compositional multi-view diffusion.

### Description of the Related Art

Animatable three-dimensional (3D) character generation refers to the use of computational models to produce digital representations of characters that can be manipulated, posed, or animated in 3D space. Characters can include, but are not limited to, virtual humans, animals, fantastical creatures, humanoid robots, or other stylized or realistic entities. Animatable 3D character generation systems are oftentimes integrated into real-time applications, such as video games, augmented reality (AR)/virtual reality (VR) experiences, and/or the like, or used in offline pipelines for film production, digital twin simulation, synthetic data generation, and/or the like.

Conventional approaches for animatable 3D character generation include diffusion-based techniques. A diffusion model is a type of generative machine learning model that generates new data, such as an image, by starting with random noise and then gradually removing the noise through a sequence of denoising steps until a coherent output, such as a clean image that does not include noise, is produced. One class of conventional approaches employs score distillation sampling (SDS), in which 3D models of characters are distilled from large-scale two-dimensional diffusion models. SDS-based approaches are compatible with different 3D representations, including meshes, point-based structures, and volumetric fields, and are applicable to outputs derived from text or image prompts.

One drawback of conventional approaches for 3D character generation that are based on SDS is the oversaturation effect of the loss used in SDS, which can reduce the quality of the generated animatable 3D characters, such as avatars. In addition, SDS-based approaches generally require long generation times, which can make such approaches unsuitable for many use cases, such as large-scale deployments in production environments. Furthermore, 3D characters generated by SDS-based approaches frequently lack fine-grained details, resulting in lower-quality 3D characters that may lack realism.

Another conventional approach for animatable 3D character generation uses different multi-view image generation and reconstruction pipelines. In such approaches, a diffusion model first synthesizes multiple views of a character from reference inputs. Then, a reconstruction module integrates the synthesized views into a 3D representation of the character that is suitable for animation.

One drawback of conventional approaches for 3D character generation that are based on multi-view generation and reconstruction is that outputs of such approaches are constrained by the quality of the underlying reconstruction pipeline. Some reconstruction pipelines that are optimization-based can be slow and generate incomplete geometry for 3D characters, while learned large-scale reconstruction pipelines oftentimes generalize poorly when generating 3D characters with poses or body shapes that were not learned through training. For example, in scenarios where a 3D character has to be animated within complex movements or integrated into interactive simulations, reconstruction artifacts can be generated that hinder rigging and reduce visual fidelity, producing results that are less suitable for high-quality animation or production use.

As the foregoing illustrates, what is needed in the art are more effective techniques for virtual character generation.

### SUMMARY

According to some embodiments, a computer-implemented method for generating an animatable representation of a character includes generating, using a trained diffusion model, one or more predicted target image latents and a diffusion timestep. The method also includes generating, using a trained machine learning model and based on the diffusion timestep and the one or more predicted target image latents, a first global representation of the character at the diffusion timestep. The method further includes determining, based on the first global representation of the character and the diffusion timestep, a second global representation of the character, and generating, based on the second global representation of the character, the animatable representation of the character.

According to some embodiments, a computer-implemented method for generating an animatable representation of a character includes generating, based on a global representation of the character, one or more local views. The method also includes generating, based on the global representation of the character and the one or more local views, one or more local ray maps. The method further includes generating, using a trained diffusion model and a trained machine learning model and based on the one or more local views and the one or more local ray maps, one or more multi-part local views. Furthermore, the method includes generating, based on the global representation of the character and the one or more multi-part local views, a refined representation of the character.

According to some embodiments, a computer-implemented method for training a machine learning model and a diffusion model includes generating, based on multi-camera video data, one or more first input views and one or more target views, where the one or more first input views comprise a first input image of a first character and the one or more first target views comprise a first target image of the first character. The method further includes performing, based on the one or more first input views and the one or more first target views, one or more training operations to train an untrained diffusion model and an untrained machine learning model to generate a trained diffusion model and a trained machine learning model, where the trained diffusion model is trained to generate one or more predicted target image latents, and where the trained machine learning model is trained to generate a global representation of the first character, where an animatable representation of a second character is generated using the trained diffusion model and the trained machine learning model.

Further embodiments provide, among other things, non-transitory computer-readable storage media storing instructions and systems configured to implement the method set forth above.

At least one technical advantage of the disclosed techniques relative to the prior art is that the disclosed techniques mitigate oversaturation effects associated with SDS by replacing the score-distillation loss of SDS with a pose-conditioned latent diffusion process that directly denoises target image latents under camera and pose conditions. The disclosed techniques further reduce generation time by jointly training a multi-view diffusion model and a three-dimensional character representation generator, such that coherent three-dimensional avatars are generated in a single denoising process rather than in a slow optimization loop. In addition, the disclosed techniques improve generalization over conventional reconstruction pipelines by integrating local and global view refinement into the diffusion process, which enables generation of consistent geometry across a wide range of poses and body shapes. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3 is a more detailed illustration of the joint diffusion module of FIG. 1, according to various embodiments;

FIG. 4 illustrates how the model trainer of FIG. 1 trains a pose-conditioned multi-view diffusion model and a character representation generator, according to various embodiments;

FIG. 5 is a more detailed illustration of the character generation application of FIG. 1, according to various embodiments;

FIG. 6 is a more detailed illustration of the compositional character representation refiner of FIG. 1, according to various embodiments;

FIG. 7 is a flow diagram of method steps for training the pose-conditioned multi-view diffusion model and the character representation generator, according to various embodiments;

FIG. 8 is a flow diagram of method steps for generating a character, according to various embodiments;

FIG. 9 is a flow diagram of method steps for generating a coarse global character representation, according to various embodiments; and

FIG. 10 is a flow diagram of method steps for generating a refined character representation, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for animatable three-dimensional (3D) character generation. In some embodiments, a character generation application includes a joint diffusion module, which processes one or more first input views, a target pose condition, and a target camera condition and generates a coarse global character representation. The joint diffusion module includes one or more encoders, a decoder, a character representation generator, a character representation renderer, a reverse diffusion module, and a pose-conditioned multi-view diffusion model. In some embodiments, over one or more diffusion steps, the joint diffusion module uses the trained pose-conditioned multi-view diffusion model and the trained character generator to process the input views, the target pose condition, and the target camera condition and generate a coarse global character representation. At each diffusion timestep, the encoders process the input views and generate the input latents. The encoders also process the target pose condition, the target camera condition, and a noisy target image predicted at the previous diffusion timestep and generate the target latents. The joint diffusion module performs a denoising step, using the pose-conditioned diffusion model, to process the input latents and the target latents and generate one or more predicted target image latents and a timestep. The decoder processes the predicted target image latents and generates predicted target images. The trained character representation generator processes the predicted target images and the timestep and generates the global character representation at the timestep. The joint diffusion module determines whether the last diffusion step has been reached. When the joint diffusion module determines that the last diffusion step has been reached, the joint diffusion module generates the coarse global character representation based on the global character representation at the time step. When the joint diffusion module determines that the last diffusion step has not been reached, the character representation renderer processes the global character representation at the time step and generates the 3D-consistent target image predictions. The reverse diffusion module performs a reverse diffusion step, using the trained pose-conditioned multi-view diffusion model, to generate a noisy target image based on 3D-consistent target image predictions. In some embodiments, a model trainer trains the pose-conditioned multi-view diffusion model and the character representation generator based on multi-view camera video data.

During training, a multi-view camera video data processor processes the multi-camera video data and generates the second input views and the target views. The encoders process the second input views and generate the input latents. The encoders also process the target views and generate the target latents. The joint diffusion module performs one or more diffusion steps, using the untrained pose-conditioned diffusion model and the untrained one or more 3D attention layers included in the pose-conditioned diffusion model, to process the input latents and the target latents and generate one or more predicted target image latents and the timestep. The decoder processes the predicted target image latents and generates predicted target images. The character representation generator processes the predicted target images and the time step and generates the global character representation at the timestep. The character representation renderer processes the global character representation at the time step and generates the 3D-consistent target image predictions. The reverse diffusion module performs a reverse diffusion step, using the untrained pose-conditioned multi-view diffusion model, to generate a noisy target image based on 3D-consistent target image predictions. A loss calculator calculates a loss based on predicted target image latents, the noisy target image, the target views, and 3D-consistent target image predictions. The model trainer uses the loss to update the parameters of the pose-conditioned multi-view diffusion model and the character representation generator. Once the pose-conditioned multi-view diffusion model and the character representation generator are trained, the trained pose-conditioned multi-view diffusion model and the trained character representation generator can be used by the joint diffusion module to process the first input views, the target pose condition, and the target camera condition and generate the coarse global character representation.

In some embodiments, the character generation application uses the joint diffusion module and a compositional character representation refiner to process the first input views, the target pose condition, and the target camera condition and generate an animatable 3D character. In some embodiments, the joint diffusion module uses the trained pose-conditioned multi-view diffusion model and the trained character representation generator to process the first input views and the target pose condition and the target camera condition and generate a coarse global character representation. In some embodiments, the compositional character representation refiner processes the predicted coarse global character representation and generates a refined global character representation. In some embodiments, the compositional character representation refiner includes a renderer, a camera-aware ray map generator, a local view refiner, and a visibility-aware character representation composer. The renderer is a module of the compositional character representation refiner that processes the coarse character representation and generates one or more coarse local views. The camera-aware ray map generator is a module of the compositional character representation refiner that processes the coarse local views and generates one or more local ray maps. The local view refiner is a module of the compositional character representation refiner that uses the trained pose-conditioned multi-view diffusion model and the trained character representation generator to process the local ray maps and the coarse local views to generate one or more multi-part local views. The visibility-aware character representation composer is an application that composes the multi-part camera views and the coarse local views together to generate the refined character representation. The character generation application then outputs the refined global character as the animatable 3D character.

The animatable 3D character generation techniques of the present disclosure have many real-world applications. For example, the animatable 3D character generation techniques could be used to create digital characters in interactive applications, such as video games, simulations, or virtual production environments. As another example, the techniques could be applied to generate characters with movable joints, such as humanoid avatars, animal characters, or robotic figures, for use in animated media, training simulators, or immersive virtual experiences.

The above examples are not in any way intended to be limiting. As persons skilled in the art will appreciate, as a general matter, the robot control techniques described herein can be implemented in any suitable application.

### System Overview

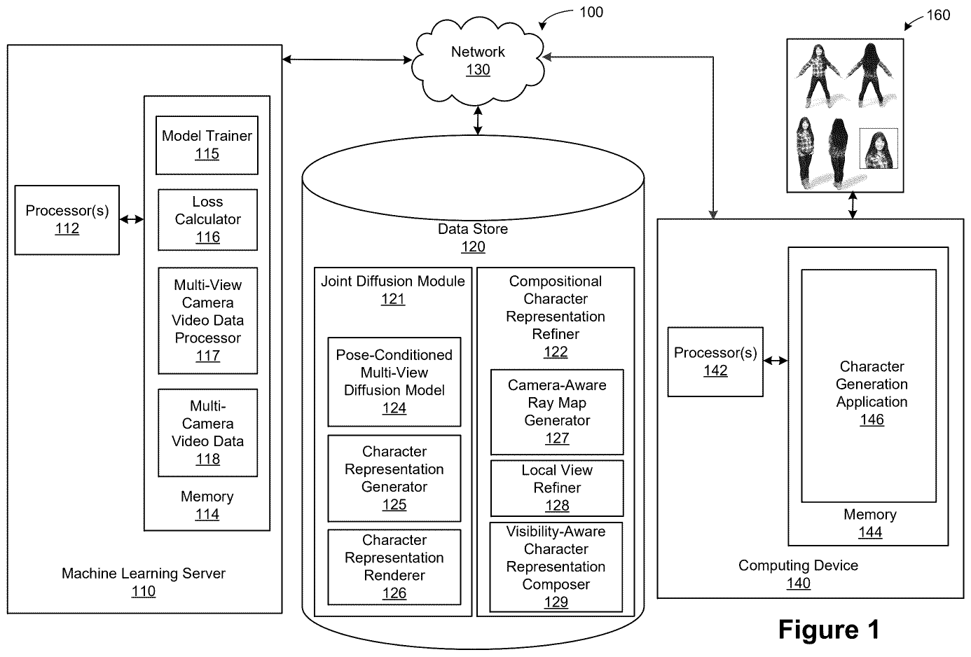

FIG. 1 illustrates a block diagram of a computer-based system 100 configured to implement one or more aspects of at least one embodiment. As shown, system 100 includes a machine learning server 110, a data store 120, and a computing device 140 in communication over a network 130, which can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a model trainer 115, a loss calculator 116, a multi-view camera video data processor 117, and multi-view camera video data 118. Data store 120 includes, without limitation, a joint diffusion module 121 and a compositional character representation refiner 122. Joint diffusion module 121 includes, without limitation, a pose-conditioned multi-view diffusion model 124, a character representation generator 125, and a character representation renderer 126. Compositional character representation refiner 122 includes, without limitation, a camera-aware ray map generator 127, a local view refiner 128, and a visibility-aware character representation composer 129. Computing device 140 includes, without limitation, processor(s) 142 and a memory 144. Memory 144 includes, without limitation, a character generation application 146.

Processor(s) 112 receive user input from input devices, such as a keyboard or a mouse. Processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in system memory 114 can be modified as desired. Further, the connection topology between the various units in FIG. 1 can be modified as desired. In some embodiments, any combination of processor(s) 112, system memory 114, and/or GPU(s) can be included in and/or replaced with any type of virtual computing system, distributed computing system, and/or cloud computing environment, such as a public, private, or a hybrid cloud system.

As shown, multi-view camera video data processer 117 executes on one or more processors 112 of machine learning server 110 and is stored in system memory 114 of machine learning server 110. In some embodiments, multi-view camera video data processor 117 is an application or module thereof that processes multi-video camera video data 118 and generates one or more input views and one or more target views. Multi-view camera video data 118 that is stored memory 114 or elsewhere (e.g., datastore 120) includes image sequences (e.g., video frames) captured from multiple camera perspectives, together with associated pose information, camera parameters, and synchronization metadata. In some embodiments, multi-view camera video data 118 can include publicly available or proprietary multi-view datasets, such as MVHumanNet or rendered images from CustomHuman, or other similar multi-view human video corpora. The input views include reference character images with corresponding pose condition and camera condition, such as intrinsics, ray maps, and/or the like. The target views include additional synchronized character images from other camera positions with corresponding pose and camera conditions.

As shown, model trainer 115 is an application that executes on one or more processors 112 of machine learning server 110 and is stored in a system memory 114 of machine learning server 110. Although shown as distinct from the loss calculator 116 and multi-view camera video data processor 117 for illustrative purposes, in some embodiments, functionality of model trainer 115, loss calculator 116, and multi-view camera video data processor 117 can be combined into a single application.

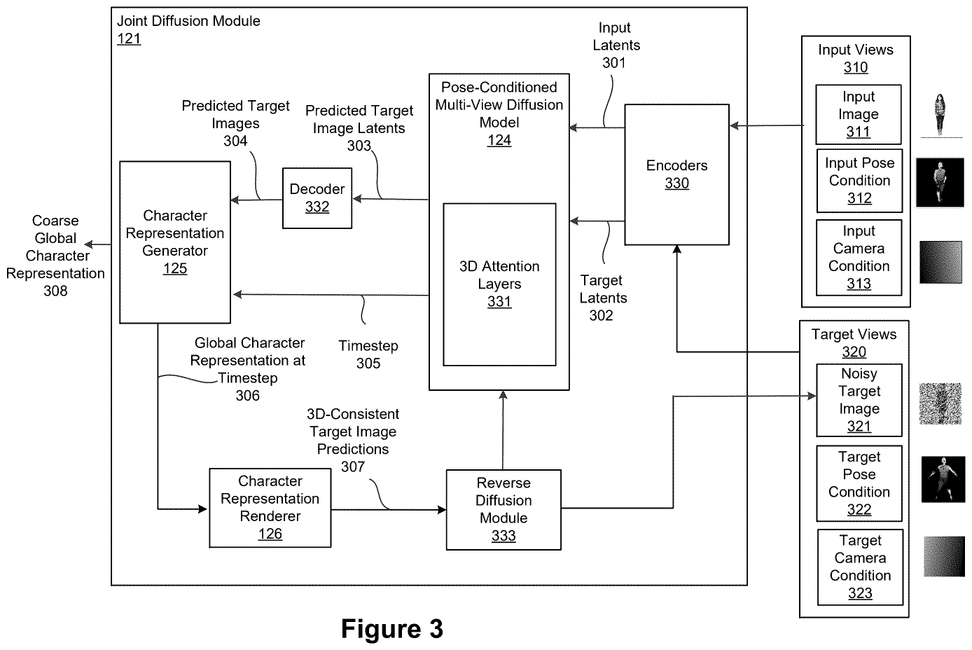

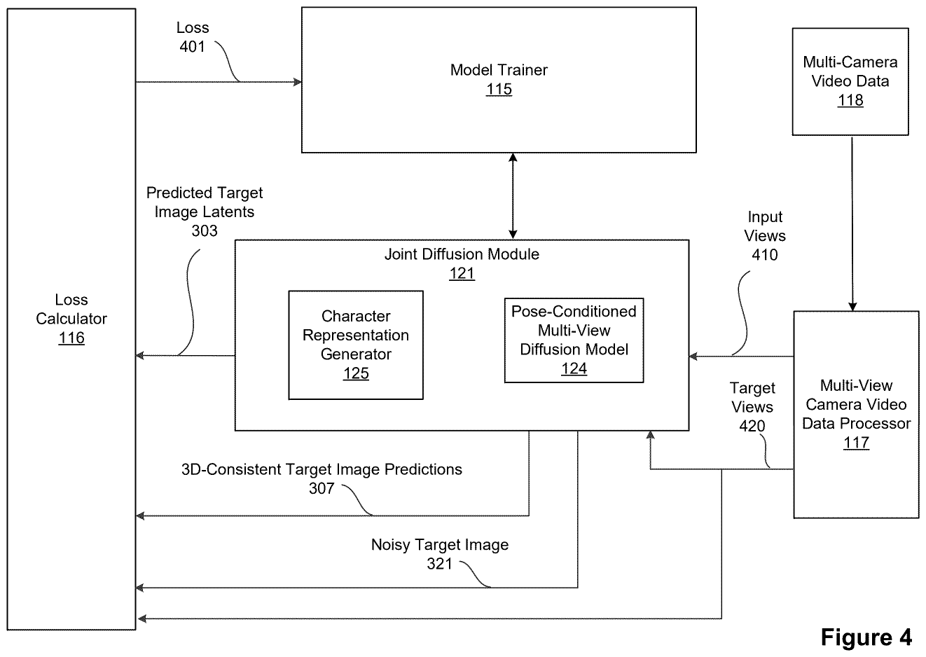

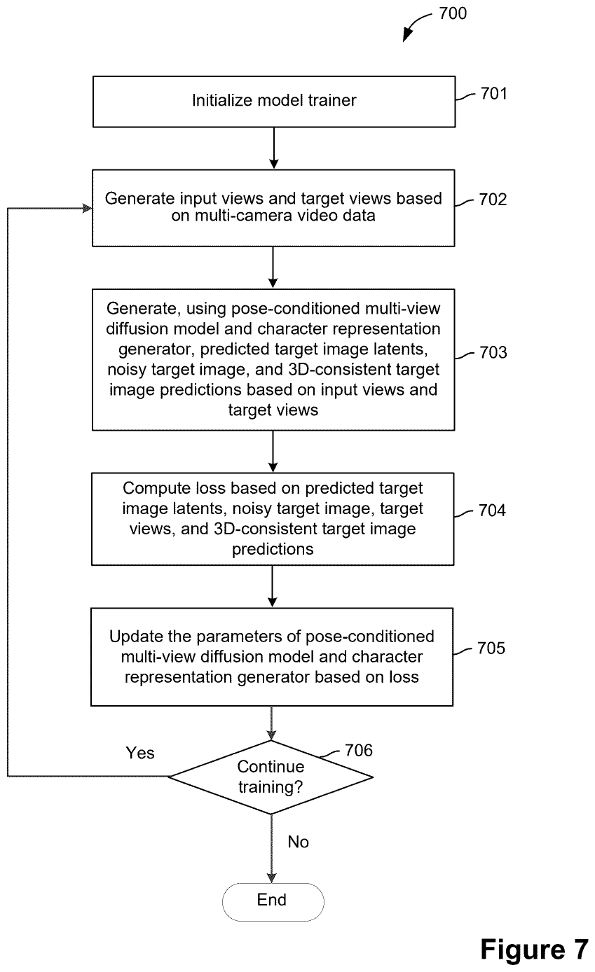

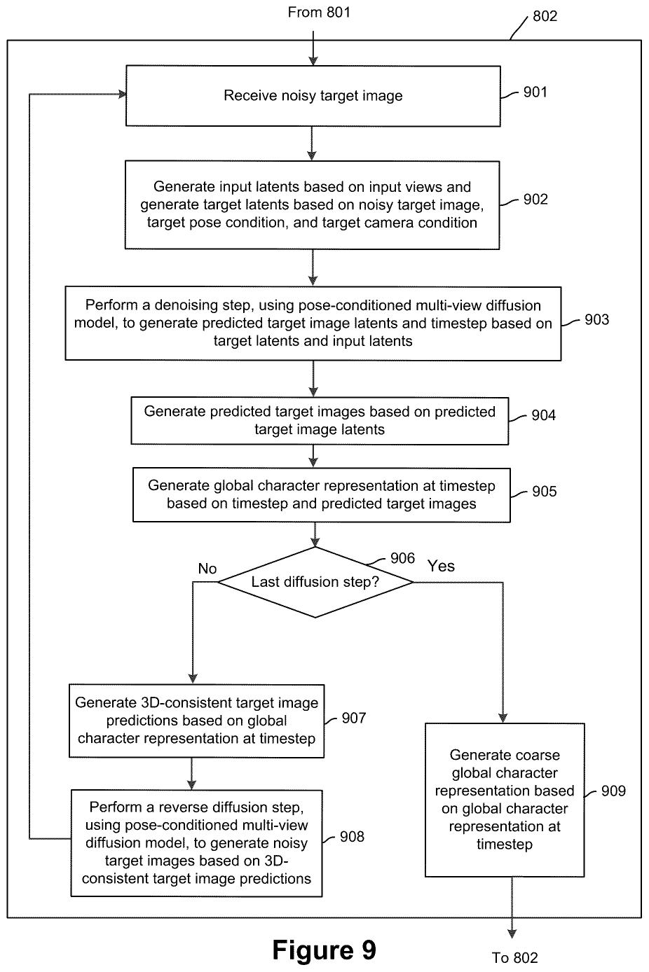

In some embodiments, model trainer 115 is configured to train one or more machine learning models, including pose-conditioned multi-view diffusion model 124 and character representation generator 125, which are included in joint diffusion module 121. Pose-conditioned multi-view diffusion model 124 is a machine learning model, such as a neural network, which is trained to generate one or more predicted target image latents. Character representation generator 125 is a machine learning model, such as a neural network, which is trained to generate a global character representation. Joint diffusion module 121 is described in greater detail in conjunction with at least FIGS. 3 and 9. Techniques for training pose-conditioned multi-view diffusion model 124 and character representation generator 125 based on multi-view camera video data 118 are discussed in greater detail herein in conjunction with at least FIGS. 4 and 7. Joint diffusion module 121 can be stored in data store 120. Although shown as being stored in data store 120 in FIG. 1, joint diffusion module 121 can be stored in memory 114 during training or can be stored in memory 144 during inference. In some embodiments, the same computing device(s) can be used for training and inference after training, rather than the separate machine learning server 110 and computing device 140. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

As shown, loss calculator 116 executes on one or more processors 112 of machine learning server 110 and is stored in system memory 114 of machine learning server 110. In some embodiments, loss calculator 116 is an application or module thereof that calculates a loss for training pose-conditioned multi-view diffusion model 124 and character representation generator 125 based on the predicted target image latents, one or more noisy target image, and one or more 3D-consistent target image predictions.

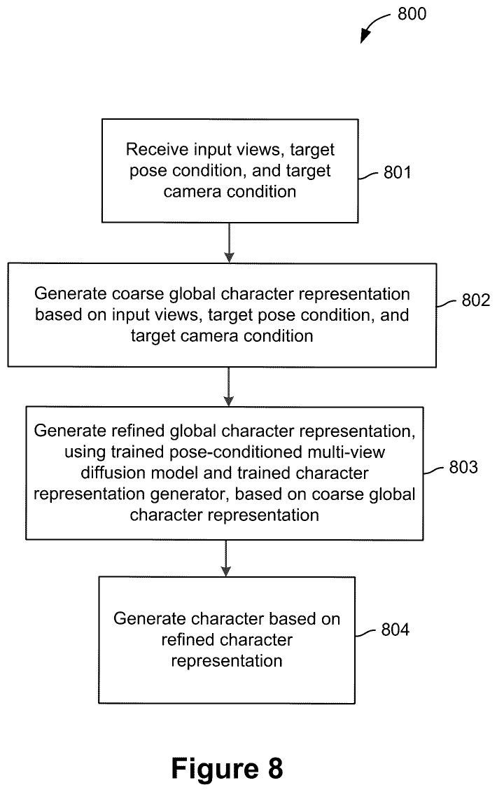

As shown, a character generation application 146 that uses joint diffusion module 121 and compositional character representation refiner 122 is stored in memory 144, and executes on processor(s) 142, of computer device 140. Once trained, pose-conditioned multi-view diffusion model 124 and character representation generator 125 can be deployed, such as via joint diffusion module 121 and compositional character representation refiner 122 included in character generation application 146, to process one or more input views, a target pose condition, and a target camera condition. Memory 144 and the processor(s) 142 can be similar to memory 114 and processor(s) 112 of machine learning server 110, described above. Character generation application 146 can be used to generate animatable 3D character, such as character 160. Although an example of character 160 is shown for illustrative purposes, in at least one embodiment, techniques disclosed herein can be applied to generate any virtual character, such as an animal or an object. Character generation application 146 is discussed in greater detail below in conjunction with FIGS. 56 and 8-10.

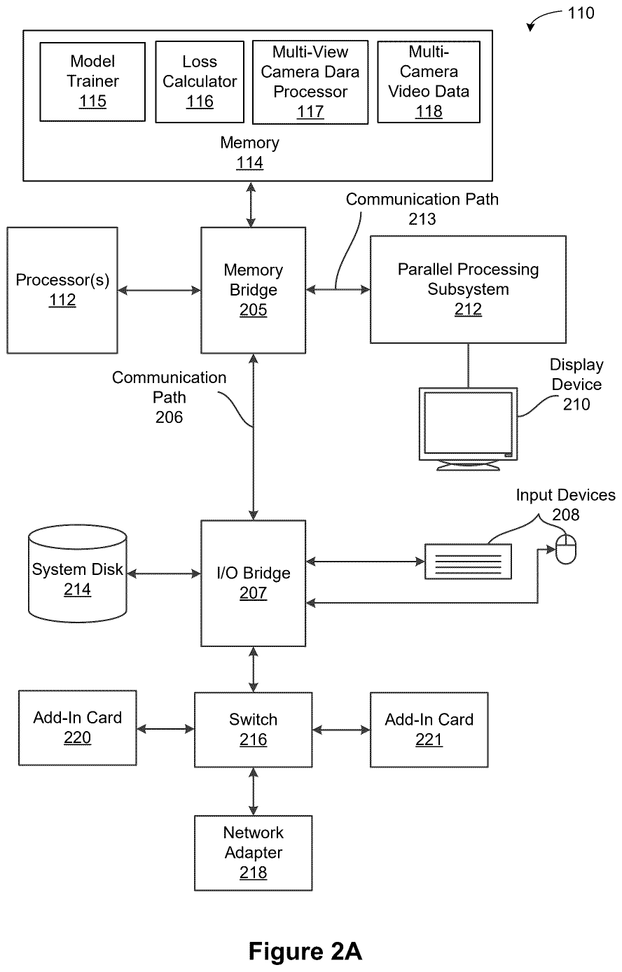

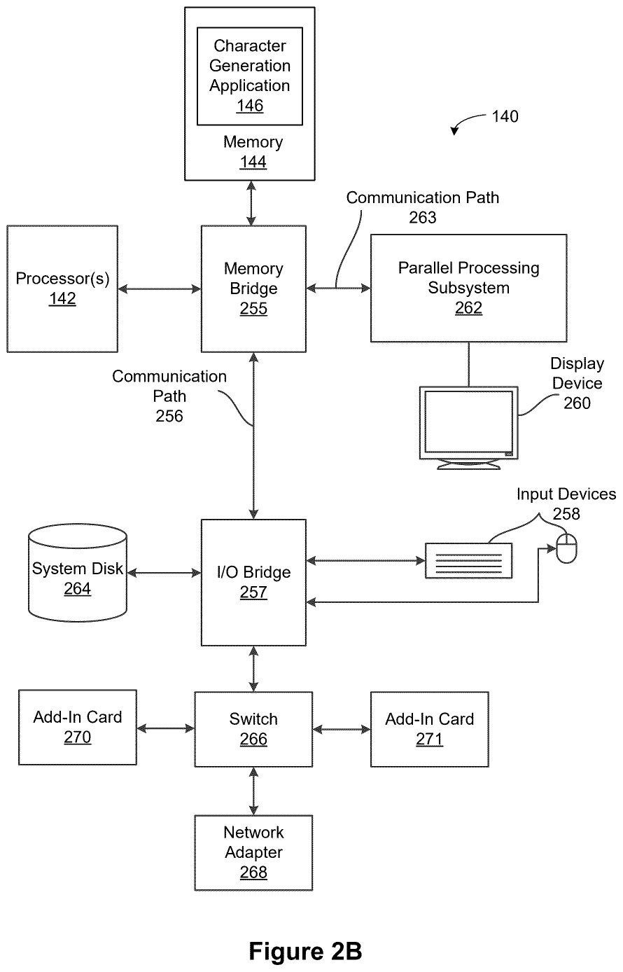

FIG. 2A is a block diagram illustrating machine learning server 110 of FIG. 1 in greater detail, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, system memory 114 includes, without limitation, model trainer 115, loss calculator 116, multi-view camera video data processor 117, and multi-view camera video data 118. Although described herein primarily with respect to model trainer 115, loss calculator 116, multi-view camera video data processor 117, and multi-view camera video data 118, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2A may not be present. For example, switch 216 could be eliminated, and network adapter 218 and add-in cards 220, 221 would connect directly to I/O bridge 207. Lastly, in certain embodiments, one or more components shown in FIG. 2A may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a block diagram illustrating computing device 140 of FIG. 1 in greater detail, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, machine learning server 110 can include one or more similar components as computing device 140.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O (input/output) bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In one embodiment, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. System memory 144 includes at least one device driver configured to manage the processing operations of the one or more PPUs within parallel processing subsystem 262. In addition, system memory 144 includes character generation application 146. Although described herein primarily with respect to character generation application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor 142. In other embodiments, parallel processing subsystem 262 may be connected to I/O bridge 257 or directly to processor 142, rather than to memory bridge 255. In still other embodiments, I/O bridge 257 and memory bridge 255 may be integrated into a single chip instead of existing as one or more discrete devices. In certain embodiments, one or more components shown in FIG. 2B may not be present. For example, switch 266 could be eliminated, and network adapter 268 and add-in cards 270, 271 would connect directly to I/O bridge 257. Lastly, in certain embodiments, one or more components shown in FIG. 2B may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 3 is a more detailed illustration of joint diffusion module 121, according to various embodiments. As shown, joint diffusion module 121 includes, without limitation, encoders 330, pose-conditioned multi-view diffusion model 124, decoder 332, character representation generator 125, character representation renderer 126, and a reverse diffusion module 333. Pose-conditioned multi-view diffusion model 124 includes, without limitation, 3D attention layers 331. Input views 310 include, without limitation, input image 311, input pose condition 312, and input camera condition 313. Target views 320 include, without limitation, noisy target image 321, target pose condition 322, and target camera condition 323. In operation, encoders 330 process input views 310 and generate input latents 301. Encoders 330 also process target views 320 and generate target latents 302. Joint diffusion module 121 performs one or more diffusion steps, using pose-conditioned diffusion model 124 and 3D attention layers 331 included in the pose-conditioned diffusion model 124, to process input latents 301 and target latents 302 and generate predicted target image latents 303 and the timestep 305. Decoder 332 processes predicted target image latents 303 and generates predicted target images 304. Character representation generator 125 processes predicted target images 304 and timestep 305 and generates global character representation at timestep 306. Character representation renderer 126 processes global character representation at timestep 306 and generates 3D-consistent target image predictions 307. Reverse diffusion module 333 performs a reverse diffusion step, using pose-conditioned multi-view diffusion model 124, to generate a noisy target image 321 based on 3D-consistent target image predictions 307.

Encoders 330 are machine learning models, such as neural networks, that process input views 310 and target views 320 and generate input latents 301 and target latents 302, respectively. In some embodiments, encoders 330 include pretrained variational autoencoder (VAE) encoders adapted from large-scale latent diffusion models, such as the autoencoder backbone used in Stable Diffusion. In some embodiments, encoders 330 include convolutional neural networks (CNNs) or transformer-based encoders configured to process auxiliary conditioning inputs included in input views 310 and target views 320, such as semantic pose maps or camera ray maps. Input latents 301 include compressed features of input views 310, while target latents 302 include compressed features of target views 320. Input pose condition 312 includes features derived from skeletal representations, keypoint maps, or parametric body models that define the structure or articulation of a character, such as character 160. Input camera condition 314 includes features derived from camera intrinsics and extrinsics, such as focal length, principal point, and camera orientation, or from camera ray maps describing per-pixel projection geometry. Target pose condition 322 and target camera condition 324 similarly include pose and camera information. In some embodiments, each input view 310 lᵢ is represented as a tuple {xᵢ, pᵢ, cᵢ}, where xᵢ corresponds to an RGB image included in input image 311, pᵢ corresponds to an input pose condition 312 in the form of a two-dimensional semantic pose map derived from a three-dimensional pose, such as rendered from the Skinned Multi-Person Linear Model (SMPL), and cᵢ corresponds to an input camera condition 313 encoded into a camera ray map using sinusoidal embeddings of the origins and directions of the camera rays. Each target view 320 Tⱼ is represented as a tuple

$$\{ {x}_{j}^{t} , {p}_{j} , {c}_{j} \} ,$$

where

$${x}_{j}^{t}$$

represents a noisy target RGB image included in noisy target image 321 at a diffusion step (e.g., timestep 305) t, pⱼ corresponds to a target pose condition 322, and cⱼ corresponds to target camera condition 323. In some embodiments, input views 310 further include both a full-body view and local views of specific body parts (e.g., head, upper body, lower body), which collectively enhance multi-scale representation. In some embodiments, encoders 330 concatenate pose conditions pᵢ and camera ray maps cᵢ with input RGB images xᵢ before encoding.

Pose-conditioned multi-view diffusion model 124 is a machine learning model, such as a diffusion model, that processes input latents 301 and target latents 302 and generates predicted target image latents 303 and timestep 305. In some embodiments, the objective of pose-conditioned multi-view diffusion model 124 is to model the conditional denoising distribution of the target RGB images

$${\{ {x}_{j}^{t - 1} \}}_{j = 1}^{K}$$

included in target views 320 given target pose condition 322 and camera parameters included in target camera condition 323

$${\{ {p}_{j} , {c}_{j} \}}_{j = 1}^{K} ,$$

input views 311

$${\{ {x}_{i} , {p}_{i} , {c}_{i} \}}_{i = 1}^{V} ,$$

and timestep 305 t, for example, described as

$$p ( {\{ {x}_{j}^{t - 1} \}}_{j = 1}^{K} \vert {\{ {p}_{j} , {c}_{j} \}}_{j = 1}^{K} , {\{ {x}_{i} , {p}_{i} , {c}_{i} \}}_{i = 1}^{V} , t ) . \qquad ( Equation 1 )$$

In some embodiments, pose-conditioned multi-view diffusion model 124 includes a U-Net backbone in which conventional two-dimensional self-attention layers are replaced with 3D attention layers 331. 3D attention layers 331 extend self-attention mechanisms across spatial and view dimensions, allowing features from input views 310 and target views 320 to be jointly aggregated. Predicted target image latents 303 include denoised latent-space features of target views 320. In some embodiments, joint diffusion module 121 performs a denoising step, using pose-conditioned multi-view diffusion model 124, to process input latents 301 and target latents 302 and generate predicted target image latents 303 and time step 305. In some embodiments, pose-conditioned multi-view diffusion model 124 uses sinusoidal positional embeddings to encode camera ray origins and directions, providing information about 3D locations across different cropping scales, for example, described as

$${LDM}_{} ( i , j ) = PE ( o ( i , j ) , d ( i , j ) ) , \qquad ( Equation 2 )$$

where PE is the sinusoidal positional encoding function, with the number of octaves N_{octaves} set to a fixed number (e.g., 8), o(i, j) is the origin of the ray for pixel (i, j), and d(i, j) is the direction of the ray for pixel (i, j). Decoder 332 is a machine learning model, such as a neural network, that processes predicted target image latents 303 and generates predicted target images 304. In some embodiments, decoder 332 is a VAE decoder pretrained on large-scale image datasets and adapted for use with latent diffusion models, such as pose-conditioned multi-view diffusion model 124. In some embodiments, decoder 332 transforms the compressed latent-space representations included in predicted target image latents 303 into pixel-space images included in predicted target images 304, reconstructing spatial details and visual features consistent with the conditioning inputs included in input views 310. Predicted target images 304 include denoised reconstructions of target views 320. In some examples, the resolution of predicted target images 304 can be of resolution 512×512, which is subsequently downsampled to resolution 256×256 for compatibility with the input resolution expected by character representation generator 125.

Character representation generator 125 is a machine learning model, such as a neural network, that processes predicted target images 304 and generates global character representation at timestep 306. In some embodiments, character representation generator 125 includes a three-dimensional Gaussian splatting (3DGS) generator. At each diffusion timestep 305 t, character representation generator 125 G generates a global character representation at timestep 306 G^{t} from image predictions included in predicted target images 304, for example, described as

$${G}^{t} = G ( {\{ {x}_{j}^{t = 0} , {x}_{j}^{t} , {p}_{j} , {c}_{j} \}}_{j = 1}^{K} , {\{ {x}_{i} , {p}_{i} , {c}_{i} \}}_{i = 1}^{V} , t ) , \qquad ( Equation 3 )$$

where

$${x}_{j}^{t = 0}$$

represents the clean predicted target images 304 obtained from one-step denoising at timestep 305 t and

$${x}_{j}^{t}$$

represents noisy target Image 321 at timestep 305 t. The resulting global character representation at timestep 306 includes a 3DGS representation or any similar neural scene representation of character 160. In some embodiments, character representation generator 125 includes the architecture of a pretrained Large Gaussian Model (LGM)-big model and includes additional input channels for processing noisy target image 321 at intermediate denoising timesteps 305. In some embodiments, compositional variants of character representation generator 125 include additional cross-part self-attention layers inserted after each cross-view attention layer of the backbone model to improve consistency across reconstructed local body regions.

Character representation renderer 126 is a machine learning model or rendering engine that processes global character representation at timestep 306 and generates 3D-consistent target image predictions 307. In some embodiments, character representation renderer 126 renders a global representation G^{t} included in global character representation at timestep 306 to generate 3D-consistent clean target image predictions 307

$${\hat{x}}_{j}^{t \to 0} .$$

Reverse diffusion module 333 is a module of joint diffusion module 121 that performs a reverse diffusion step, using pose-conditioned multi-view diffusion model 124, to process 3D-consistent target image predictions 307 and generate noisy target image 321. In some embodiments, reverse diffusion module 333 implements a sampling step of the diffusion process, in which noisy target image 321

$${x}_{j}^{t - 1}$$

is sampled from a conditional distribution, such as

$${x}_{j}^{t - 1} ∼ q ( {x}_{j}^{t - 1} \vert {x}_{j}^{t} , {\hat{x}}_{j}^{t \to 0} ) , \qquad ( Equation 4 )$$

where

$${x}_{j}^{t}$$

denotes noisy target image 321 at timestep 305 t. The resulting noisy target image 321 is included in target views 320 for subsequent denoising steps until the diffusion process converges to clean target images at timestep 305 t=0. In some embodiments, joint diffusion module 121 determines whether the last diffusion step of the denoising process has been reached. When joint diffusion module 121 determines that the last diffusion step has been reached (e.g., when timestep 305 equals zero), joint diffusion module 121 generates coarse global character representation 308 based on global character representation at timestep 306. Coarse global character representation 308 includes 3DGS representation or a similar neural scene representation of character 160 that encodes the geometry and appearance of the character 160.

FIG. 4 illustrates how model trainer 115 trains pose-conditioned multi-view diffusion model 124 and character representation generator 125, according to various embodiments. As shown, joint diffusion module 121 includes pose-conditioned multi-view diffusion model 124 and character representation generator 125. In operation, multi-view camera video data processor 117 processes multi-camera video data 118 and generates input views 410 and target views 420. Joint diffusion module 121 uses the untrained pose-conditioned diffusion model 124 and the untrained character representation generator 125 to process input views 410 and target views 420 and generate predicted target image latents 303, 3D-consistent target image predictions 307, and noisy target image 321. Loss calculator 116 calculates loss 401 based on predicted target image latents 303, noisy target image 321, target views 420, and 3D-consistent target image predictions 307. Model trainer 115 uses loss 401 to update the parameters of the untrained pose-conditioned multi-view diffusion model 124 and the untrained character representation generator 125.

Multi-view camera video data processor 117 processes multi-camera video data 118 and generates input views 410 and target views 420. In some embodiments, input views 410 include tuples of input images, input pose conditions, and input camera conditions, while target views 420 include tuples of target images, target pose conditions, and target camera conditions. In some examples, input pose conditions can include semantic pose maps derived from a 3D body model, and camera conditions can include camera ray maps encoding camera ray origins and directions. In some embodiments, during training, multi-view camera video data processor 117 randomly selects either a full-body region or a local body region (e.g., upper body, lower body, or head) from a video frame included in multi-camera video data 118. For reconstruction tasks, multi-view camera video data processor 117 selects target views 420 as three canonical viewpoints separated by 90° azimuth angles of the same body region from the same frame as input views 410. For reposing tasks, multi-view camera video data processor 117 selects target views 420 from a different frame depicting the character in a distinct pose, including four canonical viewpoints of the same body region, one of which coincides with input views 410 to account for pose differences. In some embodiments, multi-view camera video data processor 117 samples global and local training views of a character from multi-camera video data 118 based on two-dimensional joint detections and foreground masks. Each sampled view is resized to a standard resolution, such as 512×512. The local views correspond to specific body regions, including the head, upper body, and lower body, in addition to full-body crops. For example, the full-body crop can be centered at the pelvis joint with a relative scale of 1.0, the upper body crop can be centered at the neck joint with a relative scale of 0.5, the lower body crop may be centered at the left and right ankle joints with a relative scale of 0.5, and the head crop can be centered at the left and right ear joints with a relative scale of 0.25.

Joint diffusion module 121 uses the untrained pose-conditioned diffusion model 124 and the untrained character representation generator 125 to process input views 410 and target views 420 and generate predicted target image latents 303, 3D-consistent target image predictions 307, and noisy target image 321. Similar to the description above in conjunction with FIG. 3, encoders 330 process input views 410 and generate input latents 301. Encoders 330 also process target views 420 and generate target latents 302. Joint diffusion module 121 performs one or more diffusion steps, using the untrained pose-conditioned diffusion model 124, to process input latents 301 and target latents 302 and generate one or more predicted target image latents 303 and timestep 305. Decoder 332 processes predicted target image latents 303 and generates predicted target images 304. Character representation generator 125 processes predicted target images 304 and timestep 305 and generates global character representation at timestep 306. Character representation renderer 126 processes global character representation at timestep 306 and generates 3D-consistent target image predictions 307. Reverse diffusion module 333 performs a reverse diffusion step, using the untrained pose-conditioned multi-view diffusion model 124, to generate noisy target image 321 based on 3D-consistent target image predictions 307.

Loss calculator 116 is a submodule of joint diffusion module 121 that calculates loss 401 based on predicted target image latents 303, noisy target image 321, target views 420, eL_{LDM}, which is defined as the mean squared error (MSE) loss of the predicted latent noise, for example,

$${L}_{L D M} = {L}_{MSE} ( ϵ , {ϵ}_{θ} ) . \qquad ( Equation 5 )$$

$${L}_{G} = {L}_{recon} + {λ}_{reg} {L}_{reg} , \qquad ( Equation 6 )$$

where L_{recon} is a reconstruction loss that combines a MSE loss and a Learned Perceptual Image Patch Similarity (LPIPS) loss, which, in some examples, is expressed as:

$${L}_{recon} = {λ}_{MSE} {L}_{MSE} ( {\hat{x}}_{novel}^{t \to 0} , {x}_{novel} ) + {λ}_{LPIPS} {L}_{LPIPS} ( {\hat{x}}_{novel}^{t \to 0} , {x}_{novel} ) . \qquad ( Equation 7 )$$

where,

$${\hat{x}}_{novel}^{t \to 0}$$

represents the 3D-consistent target image predictions 307 generated after denoising, and xₙₒᵥₑₗ represents ground-truth novel target images sampled from target views 420. The parameters λ_{reg}, λ_{MSE}, and λ_{LPIPs} are positive constants. The regularization loss L_{reg} enforces smoothness and stability of the generated three-dimensional representation, reducing artifacts and enhancing surface quality.

In some embodiments, model trainer 115 initializes pose-conditioned multi-view diffusion model 124 using pretrained weights of a large-scale latent diffusion model, such as Stable Diffusion v1-5, and initializes character representation generator 125 from pretrained weights of a large-scale reconstruction model, such as LGM-big2. In some embodiments, model trainer 115 fine-tunes pose-conditioned multi-view diffusion model 124 in multiple stages, including training to predict canonical target views 420 of a character from one or more input views 410. For example, model trainer 115 could train pose-conditioned multi-view diffusion model 124 to predict three canonical views of a character separated by 90° azimuth angles from a single input view 410. Model trainer 115 then can fine-tune pose-conditioned multi-view diffusion model 124 on global full-body views of the character for a first fixed number of iterations, such as approximately 20,000 iterations, followed by additional fine-tuning using both global and local body views, such as head, upper body, and lower body regions, for a second fixed number of iterations, such as approximately 30,000 iterations. Furthermore, in some examples, fine-tuning can include training on four canonical target views of a novel pose from input views 410 sampled from different frames in the same video sequence included in multi-camera video data 118, for a third fixed number of iterations, such as for approximately 1,000 iterations, until convergence of loss 401. In some embodiments, model trainer 115 trains character representation generator 125 by sampling diffusion timesteps 305 and jointly optimizing the reconstruction and the regularization losses. In some examples, character representation generator 125 can first be fine-tuned for 2,000 iterations using clean full-body images, such as full-body images obtained from multi-camera video data 118, such as MVHumanNet, and then trained jointly with sampled diffusion timesteps 305 of both noisy and clean inputs for approximately 20,000 iterations. In some embodiments, model trainer 115 fine-tunes pose-conditioned multi-view diffusion model 124 for an additional fourth fixed number of iterations, such as 20,000 iterations, with training supervised using a set of reference views (e.g., twelve reference views per body part). In some embodiments, training is performed using a fixed batch size (e.g., 128) and a fixed learning rate of (e.g., 5×10⁻⁵). In some embodiments, training proceeds until one or more stopping criteria are satisfied. The stopping criteria include, but are not limited to, reaching a predefined number of training iterations (e.g., 1,000, 20,000, or 30,000 iterations depending on the training stage), achieving convergence of loss 401 below a specified threshold, or stabilizing reconstruction quality across training epochs. Once pose-conditioned multi-view diffusion model 124 and character representation generator 125 are trained, model trainer 115 stores joint diffusion module 121, which includes the trained pose-conditioned multi-view diffusion model 124 and the trained character representation generator 125, in datastore 120 or elsewhere.

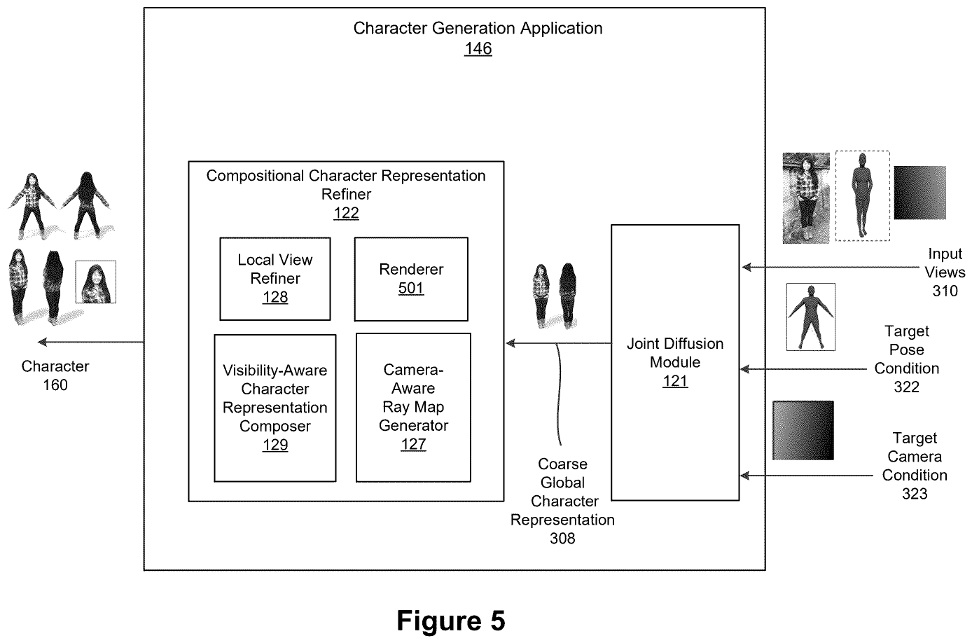

FIG. 5 is a more detailed illustration of character generation application 146, according to various embodiments. As shown, character generation application 146 includes joint diffusion module 121 and compositional character representation refiner 122. Compositional character representation refiner 122 includes a renderer 501, local view refiner 128, camera-aware ray map generator 127, and visibility-aware character representation composer 129. In operation, joint diffusion module 121 processes input views 310, target pose condition 322, and target camera condition 323 and generates coarse global character representation 308. Compositional character representation refiner 122 processes coarse global character representation 308 and generates a refined global character representation (not shown). Character generation application 146 processes the refined global character representation and generates character 160.

Joint diffusion module 121 includes, without limitation, encoders 330, pose-conditioned multi-view diffusion model 124, decoder 332, character representation generator 125, character representation renderer 126, and reverse diffusion module 333. Pose-conditioned multi-view diffusion model 124 includes, without limitation, one or more 3D attention layers 331. As described above in conjunction with FIG. 3, in some embodiments, encoders 330 process input views 310 and generate input latents 301. Encoders 330 also process target pose condition 322 and target camera condition 323 included in target views 320 and generate target latents 302. Joint diffusion module 121 performs one or more diffusion steps, using pose-conditioned diffusion model 124 and 3D attention layers 331 included in the pose-conditioned diffusion model 124, to process input latents 301 and target latents 302 and generate one or more predicted target image latents 303 and timestep 305. Decoder 332 processes predicted target image latents 303 and generates predicted target images 304. Character representation generator 125 processes predicted target images 304 and timestep 305 and generates global character representation at timestep 306. Character representation renderer 126 processes global character representation at timestep 306 and generates 3D-consistent target image predictions 307. Reverse diffusion module 333 performs a reverse diffusion step, using pose-conditioned multi-view diffusion model 124, to generate noisy target image 321 based on 3D-consistent target image predictions 307. In some embodiments, joint diffusion module 121 determines whether the last diffusion step of the denoising process has been reached. When joint diffusion module 121 determines that the last diffusion step has been reached (e.g., when timestep 305 equals zero), joint diffusion module 121 generates coarse global character representation 308 based on global character representation at timestep 306.

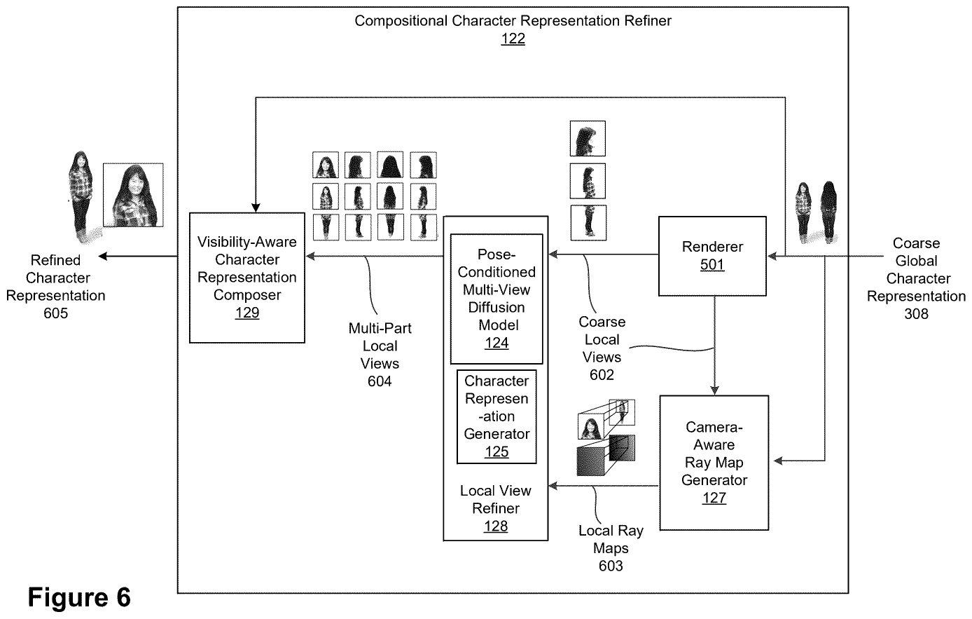

Compositional character representation refiner 122 is a module of character generation application 146 that processes coarse global character representation 308 and generates the refined global character representation. In some embodiments, compositional character representation refiner 122 includes renderer 501, camera-aware ray map generator 127, local view refiner 128, and visibility-aware character representation composer 129. Renderer 501 processes coarse global character representation 308 and generates one or more coarse local views. Camera-aware ray map generator 127 processes the coarse local views and generates one or more local ray maps. Local view refiner 128 uses the trained pose-conditioned multi-view diffusion model 124 and the trained character representation generator 125 to process the local ray maps and the coarse local views to generate one or more multi-part local views. Visibility-aware character representation composer 129 composes the multi-part camera views and the coarse local views together to generate the refined character representation. Compositional character representation refiner 122 is described in greater detail in conjunction with FIG. 6.

In some embodiments, character generation application 146 processes the refined character representation and generates character 160. The refined character representation includes a detailed 3 DGS avatar or a similar three-dimensional representation of character 160. In some embodiments, character generation application 146 converts the refined character representation into an animatable 3D character 160, which can include, for example, a human avatar with articulated body geometry, garments, and hair, a humanoid robot with movable joints, a stylized or fantastical creature, or another virtual entity suitable for animation, rendering, or simulation in interactive or offline environments. Alternatively, in some embodiments, animations can be generated using pose conditions during the diffusion described above.

FIG. 6 is a more detailed illustration of compositional character representation refiner 122, according to various embodiments. As shown, compositional character representation refiner 122 includes renderer 501, camera-aware ray map generator 127, local view refiner 128, and visibility-aware character representation composer 129. Local view refiner 128 includes the trained pose-conditioned multi-view diffusion model 124 and the trained character representation generator 125. In operation, renderer 501 processes coarse global character representation 308 and generates one or more coarse local views 602. Camera-aware ray map generator 127 processes coarse local views 602 and generates one or more local ray maps 603. Local view refiner 128 uses the trained pose-conditioned multi-view diffusion model 124 and the trained character representation generator 125 to process local ray maps 603 and coarse local views 602 to generate one or more multi-part local views 604. Visibility-aware character representation composer 129 composes multi-part camera views 604 and coarse local views 602 together to generate refined character representation 605.

Renderer 501 is a module of compositional character representation refiner 122 that processes coarse global character representation G_{coarse} 308 and generates one or more coarse local views 602. In some examples, renderer 501 renders Nᵥ=4 canonical views (e.g., front, left, back, right) for each of N_{b}=3 local body regions, such as head, upper body, and lower body, of G_{coarse}. Each coarse local view 602 is generated by applying a crop-view camera that zooms into the local body region within the original global view, where the zoom-in region is determined from 2D body joints and segmentation masks. In some examples, renderer 501 renders Nᵥ=20 coarse local views 602 separated by fixed azimuth angles to estimate 3D joints using a multi-view pose estimation system, such as EasyMocap.

Camera-aware ray map generator 127 is a module of compositional character representation refiner 122 that processes coarse local views 602 and coarse global character representation 308 and generates one or more local ray maps 603. In some embodiments, camera-aware ray map generator 127 establishes correspondences between the 3D coordinates of coarse local views 602 and global views included in coarse global character representation 308 by mapping pixels from a cropped local view region (H, W) back to the full global view. In some examples, for a pixel at coordinates (u, v) in a coarse local view 602, obtained by cropping a region (xₜₗ, yₜₗ, x_{br}, y_{br}) from the global view, the global coordinates (i, j) are computed as:

$$( i , j ) = ( {x}_{tl} + \frac{( {x}_{br} - {x}_{tl} ) \cdot u}{W} {ey}_{tl} + \frac{( {e}_{br} - {y}_{tl} ) \cdot v}{H} ) , \qquad ( Equation 8 )$$

Using the mapped coordinates, camera-aware ray map generator 127 computes the camera ray embedding included in local ray maps 603 for each local view pixel, for example, using the following equation:

$$( i , j ) = ( o ( i , j ) , o ( i , j ) \times d ( i , j ) ) , \qquad ( Equation 9 )$$

where o and d represent the origin and direction of the camera rays based on camera extrinsics.

Local view refiner 128 is a module of compositional character representation refiner 122 that uses the trained pose-conditioned multi-view diffusion model 124 and the trained character representation generator 125 to process local ray maps 603 and coarse local views 602 to generate one or more multi-part local views 604. In some embodiments, local view refiner 128 uses pose-conditioned multi-view diffusion model 124 to denoise latent representations of coarse local views 602 conditioned on local pose and camera ray maps 603, using an image-to-image editing process, such as Score-Distillation Editing (SDEdit). For example, denoising can begin at t=500 with a strength parameter s=0.5, and joint 3D diffusion can be performed across a range, such as t ∈ (350,500]. Character representation generator 125 integrates the denoised predictions across viewpoints by constructing a local three-dimensional representation, such as a Gaussian splatting representation, and re-rendering the local body region into consistent multi-part local views 604. Multi-part local views 604 include refined image outputs corresponding to different body regions, such as head, upper body, and lower body, and provide high-resolution reconstructions that capture finegrained appearance details of character 160.

Visibility-aware character representation composer 129 is a module of compositional character representation refiner 122 that composes multi-part camera views 604 and coarse global character representation 308 together to generate refined character representation 605. In some embodiments, visibility-aware character representation composer 129 uses view coverage and visibility salience metrics to selectively merge 3D Gaussian splats across different body regions, ensuring that only consistent and high-quality splats are preserved in the final refined character representation 605. In some embodiments, for a given globally reconstructed body part G^{p} included in coarse global character representation 308 and canonical view

$${T}_{j}^{p} ,$$

where p ∈ {full, upper, lower, head} and j=0, . . . ,3 included in multi-part local views 604, each splat

$${G}_{i}^{p}$$

is evaluated by first calculating the number of input views that cover the splat, denoted

$${n}_{c} ( {G}_{i}^{p} , {T}_{2}^{p} ) .$$

A splat is considered reliable whenever that splat is covered by more than two input views, or by three input views when generated by the head part. Splats that are already well-covered by another body part of higher detail, such as the head compared to the upper body, are considered redundant. Visibility-aware character representation composer 129 then assesses visibility salience by computing the gradient magnitude of the alpha channel across rendered views, such that splats with higher visibility in overlapping body parts of similar level of detail, such as between the upper body and lower body, are deemed redundant and removed to avoid conflicts.

FIG. 7 is a flow diagram of method steps for training pose-conditioned multi-view diffusion model 124 and character representation generator 125, according to various embodiments. Although the method steps are described in conjunction with the systems of FIGS. 1-6, persons skilled in the art will understand that any system configured to perform the method steps in any order falls within the scope of the present embodiments.

As shown, a method 700 begins with step 701, where model trainer 115 is initialized. In some embodiments, model trainer 115 initializes pose-conditioned multi-view diffusion model 124 using pretrained weights of a large-scale latent diffusion model, such as Stable Diffusion v1-5, and initializes character representation generator 125 from pretrained weights of a large-scale reconstruction model, such as LGM-big2. In some embodiments, training is performed using a fixed batch size (e.g., 128) and a fixed learning rate of (e.g., 5×10⁻⁵). In some embodiments, model trainer 115 also initializes the parameters λ_{reg}, λ_{MSE}, and λ_{LPIPS} as described in Equations 6 and 7.

At step 702, multi-view camera video data processor 117 generates input views 410 and target views 420 based on multi-camera video data 118. In some embodiments, during training, multi-view camera video data processor 117 randomly selects either a full-body region or a local body region (e.g., upper body, lower body, or head) from a video frame included in multi-camera video data 118. For reconstruction tasks, multi-view camera video data processor 117 selects target views 420 as three canonical viewpoints separated by 90° azimuth angles of the same body region from the same frame as input views 410. For reposing tasks, multi-view camera video data processor 117 selects target views 420 from a different video frame depicting the character in a distinct pose, including four canonical viewpoints of the same body region, one of which coincides with input views 410 to account for pose differences. In some embodiments, multi-view camera video data processor 117 samples global and local training views of a character from multi-camera video data 118 based on two-dimensional joint detections and foreground masks. Each sampled view is resized to a standard resolution, such as 512×512. The local views correspond to specific body regions, including the head, upper body, and lower body, in addition to full-body crops. For example, the full-body crop can be centered at the pelvis joint with a relative scale of 1.0, the upper body crop can be centered at the neck joint with a relative scale of 0.5, the lower body crop may be centered at the left and right ankle joints with a relative scale of 0.5, and the head crop can be centered at the left and right ear joints with a relative scale of 0.25.

At step 703, joint diffusion module 121 generates, using pose-conditioned multi-view diffusion model 125 and character representation generator 125, predicted target image latents 303, noisy target image 321, and 3D-consistent target image predictions 307 based on input views 410 and target views 420. In some embodiments, encoders 330 process input views 410 and generate input latents 301. Encoders 330 also process target views 420 and generates target latents 302. Joint diffusion module 121 performs one or more diffusion steps, using the untrained pose-conditioned diffusion model 124, to process input latents 301 and target latents 302 and generate one or more predicted target image latents 303 and timestep 305. Decoder 332 processes predicted target image latents 303 and generates predicted target images 304. Character representation generator 125 processes predicted target images 304 and timestep 305 and generates global character representation at timestep 306. Character representation renderer 126 processes global character representation at timestep 306 and generates 3D-consistent target image predictions 307. Reverse diffusion module 333 performs a reverse diffusion step, using the untrained pose-conditioned multi-view diffusion model 124, to generate noisy target image 321 based on 3D-consistent target image predictions 307.

At step 704, loss calculator 116 computes loss 401 based on predicted target image latents 303, noisy target image 321, target views 420, and 3D-consistent target image predictions 307. In some embodiments, loss 401 includes the training loss of pose-conditioned multi-view diffusion model 124, which is defined as the MSE loss of the predicted latent noise, for example, as described in Equation 5. In some embodiments, loss 401 includes the training loss of character representation generator 125, for example, as given in Equation 6, which includes a reconstruction loss that combines an MSE loss and an LPIPS loss, which, in some examples, is described by Equation 7.

At step 705, model trainer 115 updates the parameters of pose-conditioned multi-view diffusion model 124 and character representation generator 125 based on loss 401. In some embodiments, model trainer 115 fine-tunes pose-conditioned multi-view diffusion model 124 in multiple stages, including training to predict canonical target views 420 of a character from one or more input views 410. For example, model trainer 115 could train pose-conditioned multi-view diffusion model 124 to predict three canonical views of a character separated by 90° azimuth angles from a single input view 410. Model trainer 115 then can fine-tune pose-conditioned multi-view diffusion model 124 on global full-body views of the character for a first fixed number of iterations, such as approximately 20,000 iterations, followed by additional fine-tuning using both global and local body views, such as head, upper body, and lower body regions, for a second fixed number of iterations, such as approximately 30,000 iterations. Furthermore, in some examples, fine-tuning can include training on four canonical target views of a novel pose from input views 410 sampled from different frames in the same video sequence included in multi-camera video data 118, for a third fixed number of iterations, such as for approximately 1,000 iterations, until convergence of loss 401. In some embodiments, model trainer 115 trains character representation generator 125 by sampling diffusion timesteps 305 and jointly optimizing the reconstruction and the regularization losses. In some examples, character representation generator 125 can first be fine-tuned for 2,000 iterations using clean full-body images, such as full-body images obtained from multi-camera video data 118, such as MVHumanNet, and then trained jointly with sampled diffusion timesteps 305 of both noisy and clean inputs for approximately 20,000 iterations. In some embodiments, model trainer 115 fine-tunes pose-conditioned multi-view diffusion model 124 for an additional fourth fixed number of iterations, such as 20,000 iterations, with training supervised using a set of reference views (e.g., twelve reference views per body part).

At step 706, model trainer 115 determines whether to continue training. In some embodiments, training proceeds until one or more stopping criteria are satisfied. The stopping criteria include, but are not limited to, reaching a predefined number of training iterations (e.g., 1,000, 20,000, or 30,000 iterations depending on the training stage), achieving convergence of loss 401 below a specified threshold, or stabilizing reconstruction quality across training epochs. When model trainer 115 determines to continue training, the method 700 returns to step 702. When model trainer 115 determines not to continue training, the method 700 terminates. Once pose-conditioned multi-view diffusion model 124 and character representation generator 125 are trained, model trainer 115 stores joint diffusion module 121, which includes the trained pose-conditioned multi-view diffusion model 124 and the trained character representation generator 125, in datastore 120 or elsewhere.

FIG. 8 is a flow diagram of method steps for generating character 160, according to various embodiments. Although the method steps are described in conjunction with the systems of FIGS. 1-6, persons skilled in the art will understand that any system configured to perform the method steps in any order falls within the scope of the present embodiments.

As shown, a method 800 begins with step 801, where joint diffusion module 121 receives input views 310, target pose condition 322, and target camera condition 323. Input views 310 include reference character images with corresponding pose condition and camera condition, such as intrinsics, ray maps, and/or the like. Target pose condition 322 includes features derived from skeletal representations, keypoint maps, or parametric body models that define the structure or articulation of a character, such as character 160. Target camera condition 324 includes features derived from camera intrinsics and extrinsics, such as focal length, principal point, and camera orientation, or from camera ray maps describing per-pixel projection geometry. In some embodiments, each input view 310 lᵢ is represented as a tuple {xᵢ, pᵢ, cᵢ}, where xᵢ corresponds to an RGB image included in input image 311, pᵢ corresponds to an input pose condition 312 in the form of a two-dimensional semantic pose map derived from a three-dimensional pose, such as rendered from the SMPL, and cᵢ corresponds to an input camera condition 313 encoded into a camera ray map using sinusoidal embeddings of the origins and directions of the camera rays. Each target view 320 Tⱼ is represented as a tuple

$$\{ {x}_{j}^{t} , {p}_{j} , {c}_{j} \} ,$$

where

$${x}_{j}^{t}$$

represents a noisy target RGB image included in noisy target image 321 at a diffusion step (e.g., timestep 305) t, pⱼ corresponds to a target pose condition 322, and cⱼ corresponds to target camera condition 323. In some embodiments, input views 310 further include both a full-body view and local views of specific body parts (e.g., head, upper body, lower body), which collectively enhance multi-scale representation.

At step 802, joint diffusion module 121 generates coarse global character representation 308 based on input views 310, target pose condition 322, and target camera condition 323. In some embodiments, encoders 330 process input views 310 and generate input latents 301. Encoders 330 also process target pose condition 322 and target camera condition 323 included in target views 320 and generate target latents 302. Joint diffusion module 121 performs one or more diffusion steps, using pose-conditioned diffusion model 124 and 3D attention layers 331 included in the pose-conditioned diffusion model 124, to process input latents 301 and target latents 302 and generate one or more predicted target image latents 303 and timestep 305. Decoder 332 processes predicted target image latents 303 and generates predicted target images 304. Character representation generator 125 processes predicted target images 304 and timestep 305 and generates global character representation at timestep 306. Character representation renderer 126 processes global character representation at timestep 306 and generates 3D-consistent target image predictions 307. Reverse diffusion module 333 performs a reverse diffusion step, using pose-conditioned multi-view diffusion model 124, to generate noisy target image 321 based on 3D-consistent target image predictions 307. In some embodiments, joint diffusion module 121 determines whether the last diffusion step of the denoising process has been reached. When joint diffusion module 121 determines that the last diffusion step has been reached (e.g., when timestep 305 equals zero), joint diffusion module 121 generates coarse global character representation 308 based on global character representation at timestep 306. Step 802 is described in greater detail in conjunction with FIG. 9.

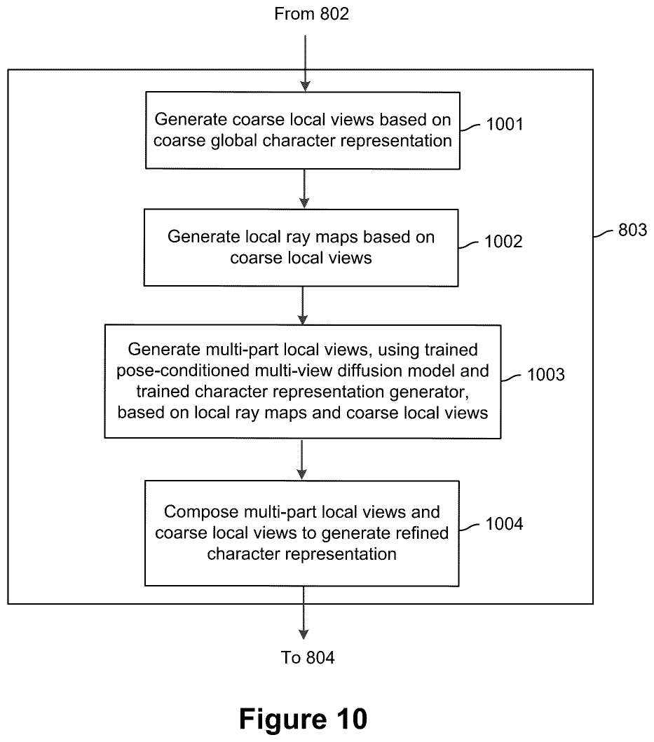

At step 803, character representation refiner 122 generates refined global character representation 605, using trained pose-conditioned multi-view diffusion model 124 and trained character representation generator 125, based on coarse global character representation 308. In some embodiments, renderer 501 processes coarse global character representation 308 and generates one or more coarse local views 602. Camera-aware ray map generator 127 processes coarse local views 602 and generates one or more local ray maps 603. Local view refiner 128 uses the trained pose-conditioned multi-view diffusion model 124 and the trained character representation generator 125 to process local ray maps 603 and coarse local views 602 to generate one or more multi-part local views 604. Visibility-aware character representation composer 129 composes multi-part camera views 604 and coarse local views 602 together to generate refined character representation 605. Step 803 is described in greater detail in conjunction with FIG. 10.

At step 804, character generation application 146 generates character 160 based on refined character representation 605. In some embodiments, character generation application 146 converts refined character representation 605 into an animatable 3D character 160, which can include, for example, a human avatar with articulated body geometry, garments, and hair, a humanoid robot with movable joints, a stylized or fantastical creature, or another virtual entity suitable for animation, rendering, or simulation in interactive or offline environments. Alternatively, in some embodiments, animations can be generated using pose conditions during diffusion.

FIG. 9 is a flow diagram of method steps for generating coarse global character representation 308, according to various embodiments. Although the method steps are described in conjunction with the systems of FIGS. 1-6, persons skilled in the art will understand that any system configured to perform the method steps in any order falls within the scope of the present embodiments.

As shown, step 802 begins with step 901, where encoders 330 receive noisy target image 321. In some embodiments, noisy target image 321 is included in target views 320 for subsequent denoising steps until the diffusion process converges to clean target images at the last timestep 305 t=0.

At step 902, encoders 330 generates input latents 301 based on input views 310 and generate target latents 302 based on noisy target image 321, target pose condition 322, and target camera condition 323. In some embodiments, encoders 330 include pretrained VAE encoders adapted from large-scale latent diffusion models, such as the autoencoder backbone used in Stable Diffusion. In some embodiments, encoders 330 include CNNs or transformer-based encoders configured to process auxiliary conditioning inputs included in input views 310 and target views 320, such as semantic pose maps or camera ray maps. In some embodiments, encoders 330 concatenate pose conditions pᵢ and camera ray maps cᵢ with input RGB images xᵢ before encoding.

At step 903, joint diffusion module 121 performs a denoising step, using pose-conditioned multi-view diffusion model 124, to generate predicted target image latents 303 and timestep 305 based on target latents 302 and input latents 301. In some embodiments, the objective of pose-conditioned multi-view diffusion model 124 is to model the conditional denoising distribution of the target RGB images

$${\{ {x}_{j}^{t - 1} \}}_{j = 1}^{K}$$

included in target views 320 given target pose condition 322 and camera parameters included in target camera condition 323

$${\{ {p}_{j} , {c}_{j} \}}_{j = 1}^{K} ,$$

input views 311

$${\{ {x}_{i} , {p}_{i} , {c}_{i} \}}_{i = 1}^{V} ,$$

and timestep 305 t, for example, as described in Equation 1. In some embodiments, pose-conditioned multi-view diffusion model 124 includes a U-Net backbone in which conventional two-dimensional self-attention layers are replaced with 3D attention layers 331. 3D attention layers 331 extend self-attention mechanisms across spatial and view dimensions, allowing features from input views 310 and target views 320 to be jointly aggregated. In some embodiments, pose-conditioned multi-view diffusion model 124 uses sinusoidal positional embeddings to encode camera ray origins and directions, providing information about 3D locations across different cropping scales, for example, as described in Equation 2.

At step 904, decoder 332 generates predicted target images 304 based on predicted target image latents 303. In some embodiments, decoder 332 is a VAE decoder pretrained on large-scale image datasets and adapted for use with latent diffusion models, such as pose-conditioned multi-view diffusion model 124. In some embodiments, decoder 332 transforms the compressed latent-space representations included in predicted target image latents 303 into pixel-space images included in predicted target images 304, reconstructing spatial details and visual features consistent with the conditioning inputs included in input views 310. In some examples, the resolution of predicted target images 304 can be of resolution 512×512, which is subsequently downsampled to resolution 256×256 for compatibility with the input resolution expected by character representation generator 125.

At step 905, character representation generator 125 generates global character representation at timestep 306 based on timestep 305 and predicted target images 304. In some embodiments, character representation generator 125 includes a 3DGS) generator. At each diffusion timestep 305 t, character representation generator 125 G generates a global character representation at timestep 306 G^{t} from image predictions included in predicted target images 304, for example, as described by Equation 3. In some embodiments, character representation generator 125 includes the architecture of a pretrained LGM-big model and includes additional input channels for processing noisy target image 321 at intermediate denoising timesteps 305. In some embodiments, compositional variants of character representation generator 125 include additional cross-part self-attention layers inserted after each cross-view attention layer of the backbone model to improve consistency across reconstructed local body regions.

At step 906, joint diffusion module 121 determines whether the last diffusion step has been reached. When joint diffusion module 121 determines that the last diffusion step has been reached (e.g., when timestep 305 equals zero), step 802 proceeds to step 909. When joint diffusion module 121 determines that the last diffusion step has not been reached, step 802 proceeds to step 907.

At step 907, character representation renderer 126 generates 3D-consistent target image predictions 307 based on the global character representation at timestep 306. In some embodiments, character representation renderer 126 renders a global representation G^{t} included in global character representation at timestep 306 to generate 3D-consistent clean target image predictions 307

$${\hat{x}}_{j}^{t \to 0} .$$

At step 908, reverse diffusion module 333 performs a reverse diffusion step, using pose-conditioned multi-view diffusion model 124, to generate noisy target image 321 based on 3D-consistent target image predictions 307. In some embodiments, reverse diffusion module 333 implements a sampling step of the diffusion process, in which noisy target image 321

$${x}_{j}^{t - 1}$$

are sampled from a conditional distribution, such as described in Equation 4.

At step 909, joint diffusion module 121 generates coarse global character representation 308 based on global character representation at timestep 306. Coarse global character representation 308 includes a 3DGS representation or a similar neural scene representation of character 160 that encodes the geometry and appearance of character 160.

FIG. 10 is a flow diagram of method steps for generating refined character representation 605, according to various embodiments. Although the method steps are described in conjunction with the systems of FIGS. 1-6, persons skilled in the art will understand that any system configured to perform the method steps in any order falls within the scope of the present embodiments.

As shown, step 803 begins with step 1001, where renderer 501 generates coarse local views 602 based on coarse global character representation 308. In some examples, renderer 501 renders Nᵥ=4 canonical views (e.g., front, left, back, right) for each of N_{b}=3 local body regions, such as head, upper body, and lower body, of G_{coarse}. Each coarse local view 602 is generated by applying a crop-view camera that zooms into the local body region within the original global view, where the zoom-in region is determined from 2D body joints and segmentation masks. In some examples, renderer 501 renders Nᵥ=20 coarse local views 602 separated by fixed azimuth angles to estimate 3D joints using a multi-view pose estimation system, such as EasyMocap.

At step 1002, camera-aware ray map generator 127 generates local ray maps 603 based on coarse local views 602. In some embodiments, camera-aware ray map generator 127 establishes correspondences between the 3D coordinates of coarse local views 602 and global views included in coarse global character representation 308 by mapping pixels from a cropped local view region (H, W) back to the full global view. In some examples, for a pixel at coordinates (u, v) in a coarse local view 602, obtained by cropping a region (xᵢₗ, yₜₗ, x_{br}, y_{br}) from the global view, the global coordinates (i, j) are computed as described in Equation 8. Using the mapped coordinates, camera-aware ray map generator 127 computes the camera ray embedding included in local ray maps 603 for each local view pixel, for example, using Equation 9.

At step 1003, local view refiner 128 generates multi-part local views 604, using trained pose-conditioned multi-view diffusion model 124 and trained character representation generator 125, based on local ray maps 603 and coarse local views 602. In some embodiments, local view refiner 128 uses pose-conditioned multi-view diffusion model 124 to denoise latent representations of coarse local views 602 conditioned on local pose and camera ray maps 603, using an image-to-image editing process, such as SDEdit. For example, denoising can begin at t=500 with a strength parameter s=0.5, and joint 3D diffusion can be performed across a range, such as t ∈ (350,500]. Character representation generator 125 integrates the denoised predictions across viewpoints by constructing a local three-dimensional representation, such as a Gaussian splatting representation, and re-rendering the local body region into consistent multi-part local views 604.

At step 1004, visibility-aware character representation composer 129 composes multi-part local views 604 and coarse global character representation 308 to generate refined character representation 605. In some embodiments, visibility-aware character representation composer 129 uses view coverage and visibility salience metrics to selectively merge 3D Gaussian splats across different body regions, ensuring that only consistent and high-quality splats are preserved in the final refined character representation 605. In some embodiments, for a given globally reconstructed body part G^{p} included in coarse global character representation 308 and canonical views

$${T}_{j}^{p} ,$$

where p ∈ {full, upper, lower, head} and j=0, . . . ,3 included in multi-part local views 604, each splat

$${G}_{i}^{p}$$

is evaluated by first calculating the number of input views that cover the splat, denoted

$${n}_{c} ( {G}_{i}^{p} , {T}_{2}^{p} ) .$$

A splat is considered reliable whenever that splat is covered by more than two input views, or by three input views when generated by the head part. Splats that are already well-covered by another body part of higher detail, such as the head compared to the upper body, are considered redundant. Visibility-aware character representation composer 129 then assesses visibility salience by computing the gradient magnitude of the alpha channel across rendered views, such that splats with higher visibility in overlapping body parts of similar level of detail, such as between the upper body and lower body, are deemed redundant and removed to avoid conflicts.

In sum, techniques are disclosed for animatable 3D character generation. In some embodiments, a character generation application includes a joint diffusion module, which processes one or more first input views, a target pose condition, and a target camera condition and generates a coarse global character representation. The joint diffusion module includes one or more encoders, a decoder, a character representation generator, a character representation renderer, a reverse diffusion module, and a pose-conditioned multi-view diffusion model. In some embodiments, over one or more diffusion steps, the joint diffusion module uses the trained pose-conditioned multi-view diffusion model and the trained character generator to process the input views, the target pose condition, and the target camera condition and generate a coarse global character representation. At each diffusion timestep, the encoders process the input views and generate the input latents. The encoders also process the target pose condition, the target camera condition, and a noisy target image predicted at the previous diffusion timestep and generate the target latents. The joint diffusion module performs a denoising step, using the pose-conditioned diffusion model, to process the input latents and the target latents and generate one or more predicted target image latents and a timestep. The decoder processes the predicted target image latents and generates predicted target images. The trained character representation generator processes the predicted target images and the timestep and generates the global character representation at the timestep. The joint diffusion module determines whether the last diffusion step has been reached. When the joint diffusion module determines that the last diffusion step has been reached, the joint diffusion module generates the coarse global character representation based on the global character representation at the time step. When the joint diffusion module determines that the last diffusion step has not been reached, the character representation renderer processes the global character representation at the time step and generates the 3D-consistent target image predictions. The reverse diffusion module performs a reverse diffusion step, using the trained pose-conditioned multi-view diffusion model, to generate a noisy target image based on 3D-consistent target image predictions. In some embodiments, a model trainer trains the pose-conditioned multi-view diffusion model and the character representation generator based on multi-view camera video data.

During training, a multi-view camera video data processor processes the multi-camera video data and generates the second input views and the target views. The encoders process the second input views and generate the input latents. The encoders also process the target views and generate the target latents. The joint diffusion module performs one or more diffusion steps, using the untrained pose-conditioned diffusion model and the untrained one or more 3D attention layers included in the pose-conditioned diffusion model, to process the input latents and the target latents and generate one or more predicted target image latents and the timestep. The decoder processes the predicted target image latents and generates predicted target images. The character representation generator processes the predicted target images and the time step and generates the global character representation at the timestep. The character representation renderer processes the global character representation at the time step and generates the 3D-consistent target image predictions. The reverse diffusion module performs a reverse diffusion step, using the untrained pose-conditioned multi-view diffusion model, to generate a noisy target image based on 3D-consistent target image predictions. A loss calculator calculates a loss based on predicted target image latents, the noisy target image, the target views, and 3D-consistent target image predictions. The model trainer uses the loss to update the parameters of the pose-conditioned multi-view diffusion model and the character representation generator. Once the pose-conditioned multi-view diffusion model and the character representation generator are trained, the trained pose-conditioned multi-view diffusion model and the trained character representation generator can be used by the joint diffusion module to process the first input views, the target pose condition, and the target camera condition and generate the coarse global character representation.

In some embodiments, the character generation application uses the joint diffusion module and a compositional character representation refiner to process the first input views, the target pose condition, and the target camera condition and generate an animatable 3D character. In some embodiments, the joint diffusion module uses the trained pose-conditioned multi-view diffusion model and the trained character representation generator to process the first input views and the target pose condition and the target camera condition and generate a coarse global character representation. In some embodiments, the compositional character representation refiner processes the predicted coarse global character representation and generates a refined global character representation. In some embodiments, the compositional character representation refiner includes a renderer, a camera-aware ray map generator, a local view refiner, and a visibility-aware character representation composer. The renderer is a module of the compositional character representation refiner that processes the coarse character representation and generates one or more coarse local views. The camera-aware ray map generator is a module of the compositional character representation refiner that processes the coarse local views and generates one or more local ray maps. The local view refiner is a module of the compositional character representation refiner that uses the trained pose-conditioned multi-view diffusion model and the trained character representation generator to process the local ray maps and the coarse local views to generate one or more multi-part local views. The visibility-aware character representation composer is an application that composes the multi-part camera views and the coarse local views together to generate the refined character representation. The character generation application then outputs the refined global character as the animatable 3D character.

At least one technical advantage of the disclosed techniques relative to the prior art is that the disclosed techniques mitigate oversaturation effects associated with SDS by replacing the score-distillation loss of SDS with a pose-conditioned latent diffusion process that directly denoises target image latents under camera and pose conditions. The disclosed techniques further reduce generation time by jointly training a multi-view diffusion model and a three-dimensional character representation generator, such that coherent three-dimensional avatars are generated in a single denoising process rather than in a slow optimization loop. In addition, the disclosed techniques improve generalization over conventional reconstruction pipelines by integrating local and global view refinement into the diffusion process, which enables consistent geometry across a wide range of poses and body shapes. These technical advantages provide one or more technological improvements over prior art approaches.

1. In some embodiments, a computer-implemented method for generating an animatable representation of a character comprises generating, using a trained diffusion model, one or more predicted target image latents and a diffusion timestep, generating, using a trained machine learning model and based on the diffusion timestep and the one or more predicted target image latents, a first global representation of the character at the diffusion timestep, determining, based on the first global representation of the character and the diffusion timestep, a second global representation of the character, and generating, based on the second global representation of the character, the animatable representation of the character.

2. The computer-implemented method of clause 1, wherein generating the one or more predicted target image latents and the diffusion timestep comprises generating, using a first encoder and based on an input image of the character, an input pose condition, and an input camera condition, one or more input latents, generating, using a second encoder and based on a noisy target image, a target pose condition, and a target camera condition, one or more target latents, and performing a denoising step using the trained diffusion model to generate the one or more predicted target image latents based on the one or more input latents and the one or more target latents.

3. The computer-implemented method of clauses 1 or 2, wherein at least one of the first encoder or the second encoder comprises a trained variational autoencoder (VAE).

4. The computer-implemented method of any of clauses 1-3, wherein generating the one or more input latents using the first encoder comprises concatenating a red-green-blue (RGB) image included in the input image of the character, the input pose condition, and a camera ray map included in the input camera condition.

5. The computer-implemented method of any of clauses 1-4, wherein the trained diffusion model comprises one or more sinusoidal positional embeddings to encode one or more camera ray origins and one or more directions included in at least one of the one or more input latents or the one or more target latents.

6. The computer-implemented method of any of clauses 1-5, wherein the trained diffusion model comprises a U-Net backbone that includes one or more three-dimensional (3D) attention layers.

7. The computer-implemented method of any of clauses 1-6, wherein generating the first global representation of the character at the diffusion timestep comprises generating, using a decoder and based on the predicted target image latents, one or more predicted target images, and generating, based on the one or more predicted target images and the timestep, the first global representation of the character at the diffusion timestep.

8. The computer-implemented method of any of clauses 1-7, wherein the trained machine learning model comprises at least one of a large Gaussian model, one or more input channels for processing a noisy target image at the diffusion timestep, or one or more cross-part self-attention layers disposed after a cross-view attention layer of a backbone model.

9. The computer-implemented method of any of clauses 1-8, wherein determining the second global representation of the character comprises, in response to determining that a last diffusion timestep has been reached, selecting the first global representation of the character at the last diffusion timestep as the second global character representation.

10. The computer-implemented method of any of clauses 1-9, wherein determining the second global representation of the character comprises, in response to determining that a last diffusion timestep has not been reached generating, based on the first global representation of the character at the diffusion timestep, one or more 3D-consistent target image predictions, and performing a reverse diffusion step using the trained diffusion model to generate a noisy target image based on the one or more 3D-consistent target image predictions.

11. In some embodiments, one or more non-transitory computer-readable media store instructions that, when executed by one or more processors, cause the one or more processors to perform the steps of generating, using a trained diffusion model, one or more predicted target image latents and a diffusion timestep, generating, using a trained machine learning model and based on the diffusion timestep and the one or more predicted target image latents, a first global representation of a character at the diffusion timestep, determining, based on the first global representation of the character and the diffusion timestep, a second global representation of the character, and generating, based on the second global representation of the character, an animatable representation of the character.

12. The one or more non-transitory computer-readable media of clause 11, wherein generating the one or more predicted target image latents and the diffusion timestep comprises generating, using a first encoder and based on an input image of the character, an input pose condition, and an input camera condition, one or more input latents, generating, using a second encoder and based on a noisy target image, a target pose condition, and a target camera condition, one or more target latents, and performing a denoising step using the trained diffusion model to generate the one or more predicted target image latents based on the one or more input latents and the one or more target latents.

13. The one or more non-transitory computer-readable media of clauses 11 or 12, wherein generating the first global representation of the character at the diffusion timestep comprises generating, using a decoder and based on the predicted target image latents, one or more predicted target images, and generating, based on the one or more predicted target images and the timestep, the first global representation of the character at the diffusion timestep.

14. The one or more non-transitory computer-readable media of any of clauses 11-13, wherein generating the one or more predicted target images using the decoder further comprises downsampling the one or more predicted target images to an input resolution expected by the trained machine learning model.

15. The one or more non-transitory computer-readable media of any of clauses 11-14, wherein the trained machine learning model comprises at least one of a large Gaussian model, one or more input channels for processing a noisy target image at the diffusion timestep, or one or more cross-part self-attention layers disposed after a cross-view attention.

16. The one or more non-transitory computer-readable media of any of clauses 11-15, wherein determining the second global representation of the character comprises, in response to determining that a last diffusion timestep has been reached, selecting the first global representation of the character at the last diffusion timestep as the second global character representation.

17. The one or more non-transitory computer-readable media of any of clauses 11-16, wherein the second global representation of the character comprises a three-dimensional (3D) Gaussian splatting representation.

18. The one or more non-transitory computer-readable media of any of clauses 11-17, wherein determining the second global representation of the character comprises, in response to determining that a last diffusion timestep has not been reached generating, based on the first global representation of the character at the diffusion timestep, one or more 3D-consistent target image predictions, and performing a reverse diffusion step using the trained diffusion model to generate a noisy target image based on the one or more 3D-consistent target image predictions.

19. The one or more non-transitory computer-readable media of any of clauses 11-18, wherein performing the reverse diffusion step using the trained diffusion model to generate the noisy target image comprises performing a sampling step of a diffusion technique in which the noisy target image is sampled from a conditional distribution.

20. In some embodiments, a system comprises one or more memories storing instructions, and one or more processors that are coupled to the one or more memories and, when executing the instructions, are configured to generate, using a trained diffusion model, one or more predicted target image latents and a diffusion timestep, generate, using a trained machine learning model and based on the diffusion timestep and the one or more predicted target image latents, a first global representation of a character at the diffusion timestep, determine, based on the first global representation of the character and the diffusion timestep, a second global representation of the character, and generate, based on the second global representation of the character, an animatable representation of the character.

1. In some embodiments, a computer-implemented method for generating an animatable representation of a character comprises generating, based on a global representation of the character, one or more local views, generating, based on the global representation of the character and the one or more local views, one or more local ray maps, generating, using a trained diffusion model and a trained machine learning model and based on the one or more local views and the one or more local ray maps, one or more multi-part local views, and generating, based on the global representation of the character and the one or more multi-part local views, a refined representation of the character.

2. The computer-implemented method of clause 1, wherein generating the one or more local views comprises rendering a first number of one or more canonical views for a second number of one or more body part regions included in the global representation of the character.

3. The computer-implemented method of clauses 1 or 2, wherein the one or more canonical views comprises at least one of a front view of the character, a left view of the character, a back view of the character, or a right view character.

4. The computer-implemented method of any of clauses 1-3, wherein generating the one or more local views comprises applying a crop-view camera that zooms into a local body region within a global view of the character included in the global representation of the character.

5. The computer-implemented method of any of clauses 1-4, wherein each local view included in the one or more local views is rendered based on a canonical viewpoint separated by a fixed azimuth angle relative to one or more other viewpoints of a body region within a global view included in the global representation of the character.

6. The computer-implemented method of any of clauses 1-5, wherein generating the one or more local ray maps comprises mapping one or more pixels from a cropped local view region included in the one or more local views to a global view included in the global representation of the character to generate one or more mapped coordinates, and computing, based on the one or more mapped coordinates, a camera ray embedding included in the one or more local ray maps.

7. The computer-implemented method of any of clauses 1-6, wherein generating the one or more multi-part local views using the trained diffusion model and the trained machine learning model comprises denoising latent representations of the one or more local views conditioned on the one or more local ray maps using an image-to-image editing technique.

8. The computer-implemented method of any of clauses 1-7, wherein the image-to-image editing technique comprises a Score-Distillation Editing technique.

9. The computer-implemented method of any of clauses 1-8, wherein generating the refined representation of the character comprises merging one or more three-dimensional Gaussian (3D) splats included in at least one of the global representation of the character or the one or more multi-part local views.

10. The computer-implemented method of any of clauses 1-9, wherein merging the one or more 3D Gaussian splats comprises applying a view coverage metric to determine whether each 3D Gaussian splat included in the one or more 3D Gaussian splats is covered by a threshold number of one or more canonical views included in the one or more multi-part local views.

11. In some embodiments, one or more non-transitory computer-readable media store instructions that, when executed by one or more processors, cause the one or more processors to perform the steps of generating, based on a global representation of a character, one or more local views, generating, based on the global representation of the character and the one or more local views, one or more local ray maps, generating, using a trained diffusion model and a trained machine learning model and based on the one or more local views and the one or more local ray maps, one or more multi-part local views, and generating, based on the global representation of the character and the one or more multi-part local views, a refined representation of the character.

12. The one or more non-transitory computer-readable media of clause 11, wherein generating the one or more local views comprises rendering a first number of one or more canonical views for a second number of one or more body part regions included in the global representation of the character.

13. The one or more non-transitory computer-readable media of clauses 11 or 12, wherein generating the one or more local views comprises applying a crop-view camera that zooms into a local body region within a global view of the character included in the global representation of the character.

14. The one or more non-transitory computer-readable media of any of clauses 11-13, wherein generating the refined representation of the character comprises merging one or more three-dimensional Gaussian (3D) splats included in at least one of the global representation of the character or the one or more multi-part local views.

15. The one or more non-transitory computer-readable media of any of clauses 11-14, wherein generating the one or more local ray maps comprises mapping one or more pixels from a cropped local view region included in the one or more local views to a global view included in the global representation of the character to generate one or more mapped coordinates, and computing, based on the one or more mapped coordinates, a camera ray embedding included in the one or more local ray maps.

16. The one or more non-transitory computer-readable media of any of clauses 11-15, wherein merging the one or more 3D Gaussian splats comprises applying a visibility salience metric to discard one or more redundant 3D Gaussian splats, wherein the visibility salience metric is computed from an alpha channel gradient across one or more canonical views included in the one or more multi-part local views.

17. The one or more non-transitory computer-readable media of any of clauses 11-16, wherein the one or more redundant 3D Gaussian splats are associated with a lower visibility salience metric than one or more other 3D Gaussian splats.

18. The one or more non-transitory computer-readable media of any of clauses 11-17, wherein merging the one or more 3D Gaussian splats comprises applying a view coverage metric to determine whether each 3D Gaussian splat included in the one or more 3D Gaussian splats is covered by a threshold number of one or more canonical views included in the one or more multi-part local views.

19. The one or more non-transitory computer-readable media of any of clauses 11-18, wherein a first 3D Gaussian splat included in the global representation of the character is considered reliable when a first 3D Gaussian splat is covered by at least one of more than two canonical views included in the one or more multi-part local views or at least three canonical views when the first 3D Gaussian splat is included in a head region of the character.

20. In some embodiments, a system comprises one or more memories storing instructions, and one or more processors that are coupled to the one or more memories and, when executing the instructions, are configured to generate, based on a global representation of a character, one or more local views, generate, based on the global representation of the character and the one or more local views, one or more local ray maps, generate, using a trained diffusion model and a trained machine learning model and based on the one or more local views and the one or more local ray maps, one or more multi-part local views, and generate, based on the global representation of the character and the one or more multi-part local views, a refined representation of the character.

1. In some embodiments, a computer-implemented method for training a machine learning model and a diffusion model comprises generating, based on multi-camera video data, one or more first input views and one or more target views, wherein the one or more first input views comprise a first input image of a first character and the one or more first target views comprise a first target image of the first character, and performing, based on the one or more first input views and the one or more first target views, one or more training operations to train an untrained diffusion model and an untrained machine learning model to generate a trained diffusion model and a trained machine learning model, wherein the trained diffusion model is trained to generate one or more predicted target image latents, and wherein the trained machine learning model is trained to generate a global representation of the first character, wherein an animatable representation of a second character is generated using the trained diffusion model and the trained machine learning model.

2. The computer-implemented method of clause 1, wherein performing the one or more training operations comprises initializing the untrained diffusion model using one or more pretrained weights of a latent diffusion model.

3. The computer-implemented method of clauses 1 or 2, wherein performing the one or more training operations comprises initializing the untrained machine learning model using one or more pretrained weights of a reconstruction model.

4. The computer-implemented method of any of clauses 1-3, wherein generating the one or more first input views and the one or more first target views comprises randomly selecting at least one of a full-body region or a local body region from a video frame included in the multi-camera video data.

5. The computer-implemented method of any of clauses 1-4, wherein generating the one or more first input views and the one or more first target views comprises selecting one or more canonical viewpoints of a body region of the first character separated by a fixed azimuth angle.

6. The computer-implemented method of any of clauses 1-5, wherein generating the one or more first input views and the one or more first target views comprises sampling one or more global training views and one or more local training views of the first character.

7. The computer-implemented method of any of clauses 1-6, wherein performing the one or more training operations comprises generating, based on the one or more first input views and the one or more first target views, one or more input latents and one or more target latents, performing a denoising step using the untrained diffusion model to generate one or more predicted target image latents and a diffusion timestep based on the one or more input latents and the one or more target latents, generating, based on the one or more predicted target image latents and the diffusion timestep, a global representation of the first character at the diffusion timestep using the untrained machine learning model, generating, based on the global representation of the first character at the timestep, one or more three dimensional (3D)-consistent target image predictions, calculating a loss based on the one or more 3D-consistent target image predictions, the one or more target views, and the one or more predicted target image latents, and updating one or more parameters of the untrained diffusion model and the untrained machine learning model based on the loss.

8. The computer-implemented method of any of clauses 1-7, wherein the one or more training operations are based on a mean squared error loss based on a predicted latent noise and an added noise.

9. The computer-implemented method of any of clauses 1-8, wherein the one or more training operations are based on a loss that comprises at least one of a learned perceptual image patch similarity loss or a mean squared error loss based on one or more 3D-consistent target image predictions and one or more ground-truth novel target images sampled from the one or more target views.

10. The computer-implemented method of any of clauses 1-9, wherein generating the animatable representation of the second character comprises generating, using the trained diffusion model and the trained machine learning model and based on one or more second input views, a target pose condition, and a target camera condition, the animatable representation of a second character, wherein the one or more second input views comprise a second input image of the second character.

11. In some embodiments, one or more non-transitory computer-readable media store instructions that, when executed by one or more processors, cause the one or more processors to perform the steps of generating, based on multi-camera video data, one or more first input views and one or more target views, wherein the one or more first input views comprise a first input image of a first character and the one or more first target views comprise a first target image of the first character, and performing, based on the one or more first input views and the one or more first target views, one or more training operations to train an untrained diffusion model and an untrained machine learning model to generate a trained diffusion model and a trained machine learning model, wherein the trained diffusion model is trained to generate one or more predicted target image latents, and wherein the trained machine learning model is trained to generate a global representation of the first character, wherein an animatable representation of a second character is generated using the trained diffusion model and the trained machine learning model.

12. The one or more non-transitory computer-readable media of clause 11, wherein performing the one or more training operations comprises generating, based on the one or more first input views and the one or more first target views, one or more input latents and one or more target latents, performing a denoising step using the untrained diffusion model to generate one or more predicted target image latents and a diffusion timestep based on the one or more input latents and the one or more target latents, generating, based on the one or more predicted target image latents and the diffusion timestep, a global representation of the first character at the diffusion timestep using the untrained machine learning model, generating, based on the global representation of the first character at the timestep, one or more three dimensional (3D)-consistent target image predictions, calculating a loss based on the one or more 3D-consistent target image predictions, the one or more target views, and the one or more predicted target image latents, and updating one or more parameters of the untrained diffusion model and the untrained machine learning model based on the loss.

13. The one or more non-transitory computer-readable media of clauses 11 or 12, wherein the one or more training operations are based on a mean squared error loss based on a predicted latent noise and an added noise.

14. The one or more non-transitory computer-readable media of any of clauses 11-13, wherein the one or more training operations are based on a loss that comprises at least one of a learned perceptual image patch similarity loss or a mean squared error loss based on one or more 3D-consistent target image predictions and one or more ground-truth novel target images sampled from the one or more target views.

15. The one or more non-transitory computer-readable media of any of clauses 11-14, wherein generating the one or more first input views and the one or more first target views comprises randomly selecting at least one of a full-body region or a local body region from a video frame included in the multi-camera video data.

16. The one or more non-transitory computer-readable media of any of clauses 11-15, wherein generating the animatable representation of the second character comprises generating, using the trained diffusion model and the trained machine learning model and based on one or more second input views, a target pose condition, and a target camera condition, the animatable representation of a second character, wherein the one or more second input views comprise a second input image of the second character.

17. The one or more non-transitory computer-readable media of any of clauses 11-16, wherein performing the one or more training operations comprises fine-tuning, based on one or more global full-body views of the first character included in the first input views, the untrained diffusion model for a first number of iterations, and fine-tuning, based on the one or more global full-body views and one or more local body views of the first character, the untrained diffusion model for a second number of iterations.

18. The one or more non-transitory computer-readable media of any of clauses 11-17, wherein performing the one or more training operations comprises performing supervised training of the untrained diffusion model using a set of reference views, wherein the set of reference views includes at least twelve reference views for each body part of the first character.

19. The one or more non-transitory computer-readable media of any of clauses 11-18, wherein performing the one or more training operations comprises sampling one or more diffusion timesteps to generate one or more sampled diffusion timesteps, and jointly optimizing, based on the one or more sampled timesteps, a reconstruction loss and a regularization loss.

20. In some embodiments, a system comprises one or more memories storing instructions, and one or more processors that are coupled to the one or more memories and, when executing the instructions, are configured to generate, based on multi-camera video data, one or more first input views and one or more target views, wherein the one or more first input views comprise a first input image of a first character and the one or more first target views comprise a first target image of the first character, and perform, based on the one or more first input views and the one or more first target views, one or more training operations to train an untrained diffusion model and an untrained machine learning model to generate a trained diffusion model and a trained machine learning model, wherein the trained diffusion model is trained to generate one or more predicted target image latents, and wherein the trained machine learning model is trained to generate a global representation of the first character, wherein an animatable representation of a second character is generated using the trained diffusion model and the trained machine learning model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating an animatable representation of a character, the method comprising:
generating, based on a global representation of the character, one or more local views;
generating, based on the global representation of the character and the one or more local views, one or more local ray maps;
generating, using a trained diffusion model and a trained machine learning model and based on the one or more local views and the one or more local ray maps, one or more multi-part local views; and
generating, based on the global representation of the character and the one or more multi-part local views, a refined representation of the character.

2. The computer-implemented method of claim 1, wherein generating the one or more local views comprises rendering a first number of one or more canonical views for a second number of one or more body part regions included in the global representation of the character.

3. The computer-implemented method of claim 2, wherein the one or more canonical views comprises at least one of a front view of the character, a left view of the character, a back view of the character, or a right view character.

4. The computer-implemented method of claim 1, wherein generating the one or more local views comprises applying a crop-view camera that zooms into a local body region within a global view of the character included in the global representation of the character.

5. The computer-implemented method of claim 1, wherein each local view included in the one or more local views is rendered based on a canonical viewpoint separated by a fixed azimuth angle relative to one or more other viewpoints of a body region within a global view included in the global representation of the character.

6. The computer-implemented method of claim 1, wherein generating the one or more local ray maps comprises:
mapping one or more pixels from a cropped local view region included in the one or more local views to a global view included in the global representation of the character to generate one or more mapped coordinates; and
computing, based on the one or more mapped coordinates, a camera ray embedding included in the one or more local ray maps.

7. The computer-implemented method of claim 1, wherein generating the one or more multi-part local views using the trained diffusion model and the trained machine learning model comprises denoising latent representations of the one or more local views conditioned on the one or more local ray maps using an image-to-image editing technique.

8. The computer-implemented method of claim 7, wherein the image-to-image editing technique comprises a Score-Distillation Editing technique.

9. The computer-implemented method of claim 1, wherein generating the refined representation of the character comprises merging one or more three-dimensional Gaussian (3D) splats included in at least one of the global representation of the character or the one or more multi-part local views.

10. The computer-implemented method of claim 9, wherein merging the one or more 3D Gaussian splats comprises applying a view coverage metric to determine whether each 3D Gaussian splat included in the one or more 3D Gaussian splats is covered by a threshold number of one or more canonical views included in the one or more multi-part local views.

11. One or more non-transitory computer-readable media storing instructions that, when executed by one or more processors, cause the one or more processors to perform the steps of:
generating, based on a global representation of a character, one or more local views;
generating, based on the global representation of the character and the one or more local views, one or more local ray maps;
generating, using a trained diffusion model and a trained machine learning model and based on the one or more local views and the one or more local ray maps, one or more multi-part local views; and
generating, based on the global representation of the character and the one or more multi-part local views, a refined representation of the character.

12. The one or more non-transitory computer-readable media of claim 11, wherein generating the one or more local views comprises rendering a first number of one or more canonical views for a second number of one or more body part regions included in the global representation of the character.

13. The one or more non-transitory computer-readable media of claim 11, wherein generating the one or more local views comprises applying a crop-view camera that zooms into a local body region within a global view of the character included in the global representation of the character.

14. The one or more non-transitory computer-readable media of claim 11, wherein generating the refined representation of the character comprises merging one or more three-dimensional Gaussian (3D) splats included in at least one of the global representation of the character or the one or more multi-part local views.

15. The one or more non-transitory computer-readable media of claim 11, wherein generating the one or more local ray maps comprises:
mapping one or more pixels from a cropped local view region included in the one or more local views to a global view included in the global representation of the character to generate one or more mapped coordinates; and
computing, based on the one or more mapped coordinates, a camera ray embedding included in the one or more local ray maps.

16. The one or more non-transitory computer-readable media of claim 15, wherein merging the one or more 3D Gaussian splats comprises applying a visibility salience metric to discard one or more redundant 3D Gaussian splats, wherein the visibility salience metric is computed from an alpha channel gradient across one or more canonical views included in the one or more multi-part local views.

17. The one or more non-transitory computer-readable media of claim 16, wherein the one or more redundant 3D Gaussian splats are associated with a lower visibility salience metric than one or more other 3D Gaussian splats.

18. The one or more non-transitory computer-readable media of claim 15, wherein merging the one or more 3D Gaussian splats comprises applying a view coverage metric to determine whether each 3D Gaussian splat included in the one or more 3D Gaussian splats is covered by a threshold number of one or more canonical views included in the one or more multi-part local views.

19. The one or more non-transitory computer-readable media of claim 18, wherein a first 3D Gaussian splat included in the global representation of the character is considered reliable when a first 3D Gaussian splat is covered by at least one of more than two canonical views included in the one or more multi-part local views or at least three canonical views when the first 3D Gaussian splat is included in a head region of the character.

20. A system, comprising:
one or more memories storing instructions, and
one or more processors that are coupled to the one or more memories and, when executing the instructions, are configured to:
generate, based on a global representation of a character, one or more local views,
generate, based on the global representation of the character and the one or more local views, one or more local ray maps,
generate, using a trained diffusion model and a trained machine learning model and based on the one or more local views and the one or more local ray maps, one or more multi-part local views, and
generate, based on the global representation of the character and the one or more multi-part local views, a refined representation of the character.
